(19) United States
(12) Patent Application Publication
(10) Pub. No.: US 2008/0140527 A1
(43) Pub. Date: Jun. 12, 2008

(54) Media network

(75) Inventors: Kristin Gray, Dallas, TX (US); David Gales, Venice, CA (US); Ken Reese, Dallas, TX (US); Jonas Woods, Dallas, TX (US); Richard Orne, Los Angeles, CA (US)

Correspondence Address: HAYNES AND BOONE, LLP, 901 Main Street, Suite 3100, Dallas, TX, 75202, US

(73) Assignee: VMN, L.P., Dallas, TX (US)

(21) Appl. No.: 11/821,978

(22) Filed: Jun. 26, 2007

Related U.S. Application Data
(60) Provisional application No. 60/817,232, filed on Jun. 28, 2006.

(51) Int. Cl. G06Q 30/00; G06Q 99/00

(52) U.S. Cl. 705/14; 705/1

(57) ABSTRACT

A media network is described. In an exemplary embodiment, the media network includes a plurality of media elements such as, for example, a plurality of display elements.

### CROSS REFERENCE TO RELATED APPLICATION

This application claims the benefit of the filing date of U.S. provisional patent application Ser. No. 60/817,232, attorney docket number 38052.1, filed on Jun. 28, 2006, the disclosure of which is incorporated herein by reference.

### BACKGROUND

The present disclosure relates, in general, to media networks and, in particular, to a multimedia network positioned in a space, such as an outdoor multimedia network positioned in an urban space.

### BRIEF DESCRIPTION OF THE DRAWINGS

FIG. 1 is a schematic illustration of an exemplary embodiment of a multimedia network including input elements and media elements.

FIG. 2 is a schematic illustration of an exemplary embodiment of the multimedia network of FIG. 1 including the input elements and the media elements including lighting elements, audio elements and display elements.

FIG. 3 is a schematic illustration of an exemplary embodiment of the input elements of FIG. 1 or 2.

FIG. 4 is a schematic illustration of an exemplary embodiment of the lighting elements of FIG. 2.

FIG. 5 is a schematic illustration of an exemplary embodiment of the audio elements of FIG. 2.

FIG. 6 is a schematic illustration of an exemplary embodiment of the display elements of FIG. 2.

FIG. 7 is a top plan view of an exemplary embodiment of the multimedia network of FIG. 1 or 2 positioned in an exemplary embodiment of an urban space.

FIG. 8 is a one point, or one vanishing point, perspective view of a portion of the multimedia network of FIG. 7, the portion including some of the display elements of FIG. 6.

FIG. 9 is an elevational view of a portion of the display elements depicted in FIG. 8

FIG. 10 is an elevational view of another portion of the display elements depicted in FIG. 8.

FIG. 11 is a perspective view of an exemplary embodiment of one of the display elements of FIG. 6.

FIG. 12 is a perspective view of an exemplary embodiment of another of the display elements of FIG. 6.

FIG. 13 is a one point, or one vanishing point, perspective view of some of the display elements depicted in FIG. 8, but depicting the display elements in another operational configuration.

FIGS. 14, 15, 16, 17, 18, 19, 20 and 21 are views similar to that of FIG. 13, but depicting the display elements in different operational configurations.

FIG. 22 is a flow chart illustration of an exemplary embodiment of a method of producing content for, submitting content to and/or displaying content over, the multimedia networks of FIG. 1, 2 or 7.

FIG. 23 is a flow chart illustration of an exemplary embodiment of a step of the method of FIG. 22.

FIG. 24 is a flow chart illustration of an exemplary embodiment of the step of FIG. 23.

FIG. 25 is a flow chart illustration of an exemplary embodiment of a step of the embodiment of FIG. 24.

FIG. 26 is a flow chart illustration of an exemplary embodiment of a step of the embodiment of FIG. 25.

FIG. 27 is a flow chart illustration of an exemplary embodiment of another step of the embodiment of FIG. 24.

FIG. 28 is a flow chart illustration of an exemplary embodiment of a step of the embodiment of FIG. 27.

FIG. 29 is a flow chart illustration of an exemplary embodiment of another step of the method of FIG. 22.

FIG. 30 is a schematic illustration of a node for implementing one or more exemplary embodiments of the present disclosure.

### DETAILED DESCRIPTION

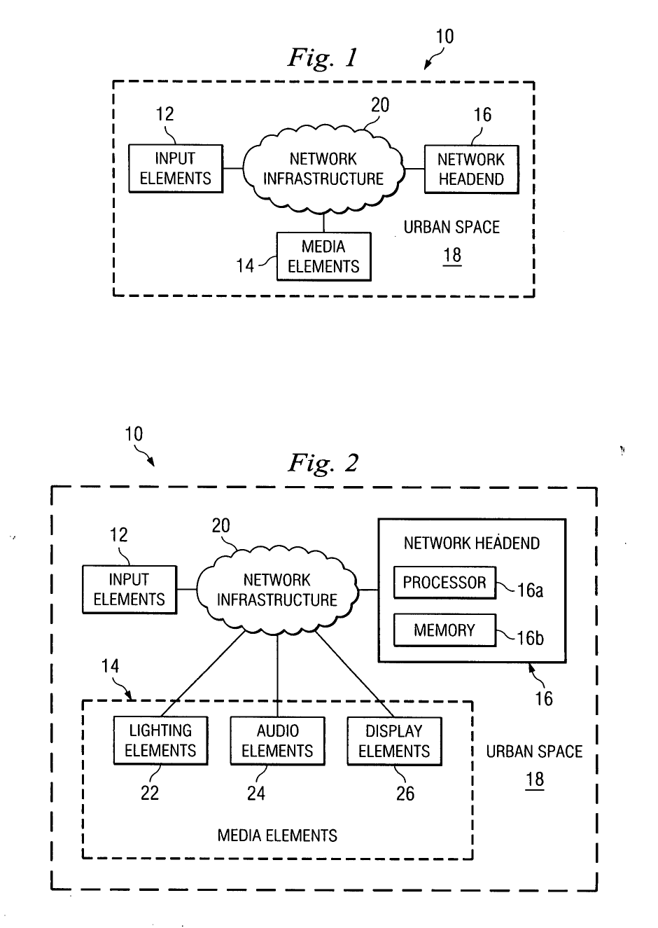

In an exemplary embodiment, as illustrated in FIG. 1, a multimedia network is generally referred to by the reference numeral 10 and includes one or more input elements 12, one or more networked media elements 14, and a network headend 16, all of which are positioned in an indoor and/or outdoor space, such as an urban space 18. The input elements 12 and the media elements 14 are operably coupled to the network headend 16 via a network infrastructure 20.

In an exemplary embodiment, the network infrastructure 20 includes a fiber-optic backbone operably coupled to the network headend 16. In several exemplary embodiments, the network infrastructure 12 includes one or more data networks such as, for example, the Internet. In several exemplary embodiments, the network infrastructure 12 includes any type of local-area network, wide-area network, client-server network, wireless network and/or any combination thereof. In several exemplary embodiments, the network infrastructure 20 may, for example, include one or more of the following: radio frequency (RF) communication interfaces, Internet Protocol (IP) communication interfaces, power line communication interfaces, other conventional communication interfaces, and/or any combination thereof.

In an exemplary embodiment, as illustrated in FIG. 2 with continuing reference to FIG. 1, the network headend 16 includes a processor 16a and a computer readable medium or memory 16b operably coupled thereto. In an exemplary embodiment, instructions accessible to, and executable by, the processor 16a are stored in the memory 16b. In an exemplary embodiment, the memory 16b includes one or more databases and/or one or more data structures. The media elements 14 include one or more lighting elements 22, one or more audio elements 24 and one or more display elements 26, all of which are operably coupled to the network headend 16 via the network infrastructure 20. The network headend 16 is adapted to monitor and control the media elements 14, including the lighting elements 22, the audio elements 24 and the display elements 26, under conditions to be described. In an exemplary embodiment, the processor 16a includes, for example, one or more of the following: a programmable controller, an application specific integrated circuit (ASIC), other conventional controller devices and/or any combination thereof.

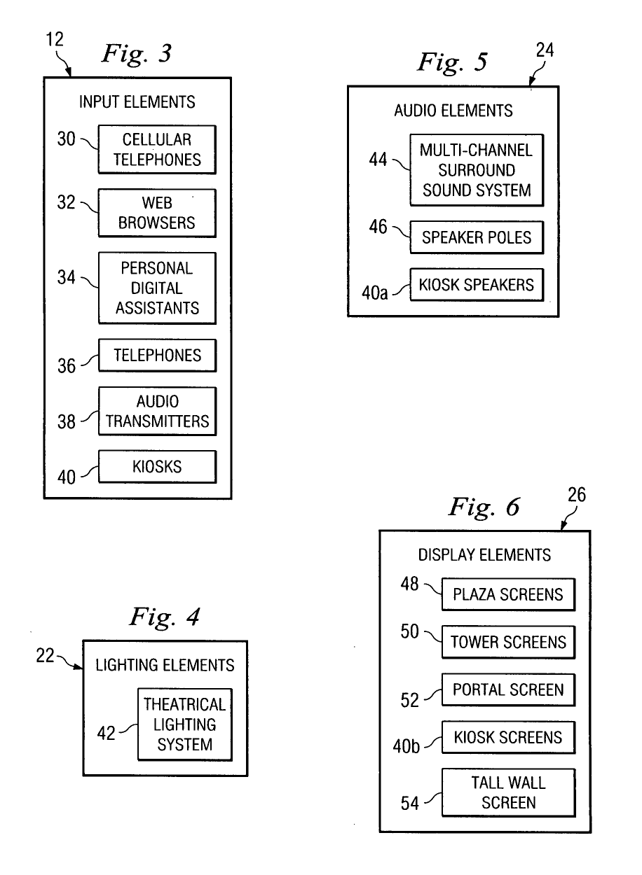

In an exemplary embodiment, as illustrated in FIG. 3 with continuing reference to FIGS. 1 and 2, the input elements 12 include one or more of the following: one or more cellular telephones 30, one or more web browsers 32 executed by personal computers, client computers and/or other computing devices, one or more personal digital assistants (PDAs) 34, one or more telephones 36, one or more audio transmitters 38, and one or more kiosks 40. Each input element 12 is adapted to be in either one or two-way communication with the network headend 16. In several exemplary embodiments, the input elements 12 are operably coupled to the network infrastructure 20 by one or more communication interfaces that may, for example, include one or more of the following: radio frequency (RF) communication interfaces, Internet Protocol (IP) communication interfaces, power line communication interfaces, other conventional communication interfaces, and/or any combination thereof. In several exemplary embodiments, instead of, or in addition to the foregoing, the input elements 12 may include a wide variety of other input devices, computing devices, computer programs executable by computing devices, user interfaces and/or any combination thereof.

In an exemplary embodiment, as illustrated in FIG. 4 with continuing reference to FIGS. 1, 2 and 3, the lighting elements 22 include a theatrical lighting system 42. In several exemplary embodiments, the theatrical lighting system 42 is adapted to permit the synchronization of lighting cues to video events, audio events and/or any combination thereof.

In an exemplary embodiment, as illustrated in FIG. 5 with continuing reference to FIGS. 1, 2, 3 and 4, the audio elements 24 include a multi-channel surround-sound system 44, one or more speaker poles 46, and one or more kiosk speakers 40a, each of which is a part of one of the kiosks 40. In an exemplary embodiment, the multi-channel surround-sound system 44 supports over a dozen audio channels. In an exemplary embodiment, the multi-channel surround-sound system 44 supports mono audio. In several exemplary embodiments, each of the speaker poles 46 includes a pole having one or more speakers mounted thereon. In several exemplary embodiments, the speaker poles 46 are part of the multi-channel surround-sound system 44, and the speakers thereof are distributed and oriented so that an immersive audio experience is adapted to be created in at least a portion of the urban space 18, under conditions to be described.

In an exemplary embodiment, as illustrated in FIG. 6 with continuing reference to FIGS. 1, 2, 3, 4 and 5, the display elements 26 include several different types of display screens, including a plurality of plaza screens 48, a plurality of tower screens 50, a portal screen 52, a tall wall screen 54 and a plurality of kiosk screens 40b, each of which is a part of one of the kiosks 40. In several exemplary embodiments, the plaza screens 48 are movable under conditions to be described. In several exemplary embodiments, one or more of the display elements 26 are networked together. In several exemplary embodiments, one or more of the plaza screens 48, one or more of the tower screens 50, the portal screen 52, and/or any combination thereof, are networked together. In an exemplary embodiment, each display element 26 is a high-impact full-motion daylight-quality video display. In an exemplary embodiment, each of the plaza screens 48, the tower screens 50 and the portal screen 52 is a high-impact full-motion daylight-quality video display.

In an exemplary embodiment, each plaza screen 48 includes a high-resolution light-emitting-diode (LED) screen. In an exemplary embodiment, each plaza screen 48 includes a 15 foot by 26 foot LED screen. In an exemplary embodiment, each plaza screen 48 includes a 15.43 foot by 26.46 foot LED screen. In an exemplary embodiment, under conditions to be described, a set of four plaza screens 48 are positioned adjacent one another to create a 31 foot by 53 foot display, or composite screen, at high-definition (HD) resolution. In an exemplary embodiment, each plaza screen 48 includes an LED screen having pixel mapping and other lighting-control capabilities so that the LED screen is adapted to respond directly to video content. In an exemplary embodiment, each plaza screen 48 includes surface-mounted-diode (SMD) LEDs. In an exemplary embodiment, each plaza screen 48 includes one or more SMD LED tiles. In an exemplary embodiment, each plaza screen 48 includes one or more SMD LED tiles incorporating Barco® OLite technology, which is available from Barco N.V. of Kortrijk, Belgium. In an exemplary embodiment, each plaza screen 48 and/or operation thereof includes, in whole or in part, one or more embodiments of LEDs, systems, methods, devices, and/or combinations thereof, described in U.S. patent application Ser. No. 10/656,606, the disclosure of which is incorporated herein by reference.

In an exemplary embodiment, each tower screen 50 includes an LED screen. In an exemplary embodiment, each tower screen 50 includes a 20 foot by 20 foot LED screen. In an exemplary embodiment, each tower screen 50 includes a liquid-crystal-display (LCD) screen.

In an exemplary embodiment, the portal screen 52 includes an LED screen. In an exemplary embodiment, the portal screen includes a 19 foot by 32 foot LED screen. In an exemplary embodiment, the portal screen 52 includes an LCD screen.

In an exemplary embodiment, the technical specifications for the plaza screens 48, the tower screens 50 and the portal screen 52 are as provided in the following table:

| | | Set of | | |
|---|---|---|---|---|
| | Plaza | Four Plaza | Tower | Portal |
| Specification | Screen 48 | Screens 48 | Screen 50 | Screen 52 |
| Quantity | 8 | 2 | 2 | 1 |
| Visual Pitch (mm) | 10.0 | 10.0 | 10.0 | 10.0 |
| Physical Pitch (mm) | 10.0 | 10.0 | 10.0 | 10.0 |
| LED Type | SMD | SMD | SMD | SMD |
| Horizontal Viewing | 145 | 145 | 145 | 145 |
| Angle (degrees) | | | | |
| Vertical Viewing | 95 | 95 | 95 | 95 |
| Angle (degrees) | | | | |
| Height (ft) | 15.43 | 31.03 | 19.84 | 18.74 |
| Width (ft) | 26.46 | 53.09 | 19.84 | 32.34 |
| Image Area (ft²) | 408.28 | 1,647.38 | 393.63 | 606.05 |
| Video Line (H × W) | 448 × 792 | 901 × 1589 | 576 × 594 | 544 × 968 |
| Maximum Brightness | 7,700 | 7,700 | 7,700 | 7,700 |
| (Nit) | | | | |

In an exemplary embodiment, the Video Line (H X W) for a set of four plaza screens 48 is 1080 pixels by 1920 pixels (standard High Definition). In an exemplary embodiment, the Video Line (H×W) for the portal screen 52 is 1080 pixels by 1920 pixels.

In an exemplary embodiment, each kiosk screen 40b includes an LCD screen. In an exemplary embodiment, each kiosk screen 40b includes an LCD screen oriented in portrait mode. In an exemplary embodiment, the kiosk screen 40b includes one or more static images.

In an exemplary embodiment, the tall wall screen 54 includes an LCD screen. In an exemplary embodiment, the tall wall screen 54 includes an LCD screen that is adapted to be mounted against a wall of a building. In an exemplary embodiment, the tall wall screen 54 includes a digital marquee. In an exemplary embodiment, the tall wall screen 54 includes a vertically-oriented and full-color static vinyl graphic display.

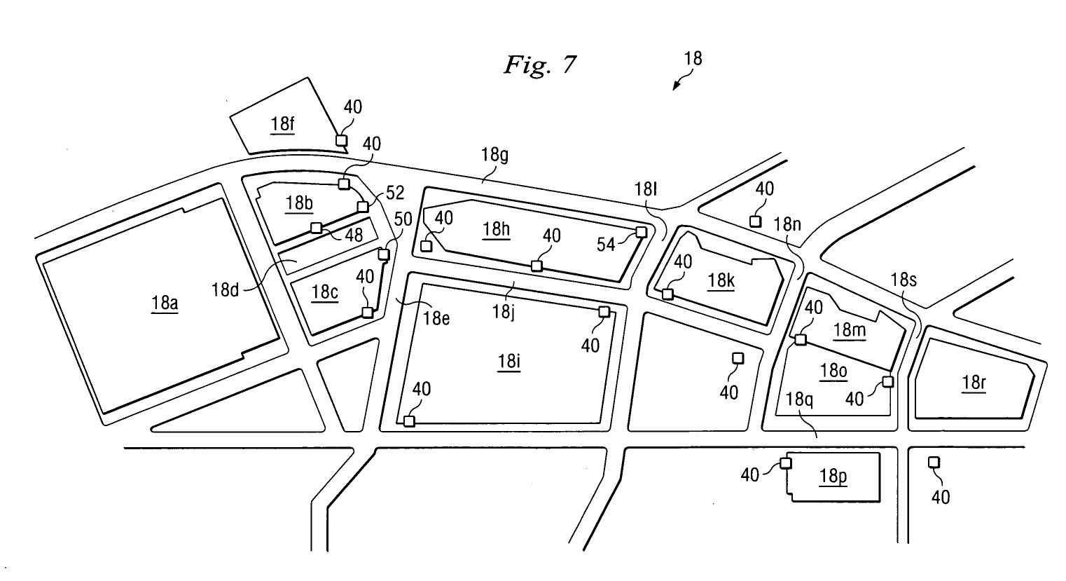

In an exemplary embodiment, as illustrated in FIG. 7, the urban space 18 is a mixed-use urban district and includes a building, such as a sports arena 18a, and buildings 18b and 18c. A common open area, in the form of a plaza 18d, is defined by the arena 18a and the buildings 18b and 18c, extending between generally parallel-spaced portions of the buildings 18b and 18c, and providing a promenade or walkway from a street 18e to one side of the arena 18a. In an exemplary embodiment, the plaza 18d is 120 feet by 300 feet. A building 18f is positioned across a street 18g from the building 18b. A building 18h is positioned across the street 18e from the building 18b, the plaza 18d and the building 18c. A building 18i is positioned across a street 18j from the building 18h. A building 18k is positioned across a street 181 from the building 18h. A building 18m is positioned across a street 18n from the building 18k. A park 18o is positioned adjacent the building 18m. A building 18p is positioned across a street 18q from the park 18o. A building 18r is positioned across a street 18s from the building 18m.

In several exemplary embodiments, one or more of the buildings 18a, 18b, 18c, 18f, 18h, 18i, 18k, 18m, 18p and 18r is a residential, retail, office, parking, arena, hotel or entertainment building. In several exemplary embodiments, one or more of the buildings 18a, 18b, 18c, 18f, 18h, 18i, 18k, 18m, 18p and 18r is a mixed-use building such as, for example, an office/retail building, a retail/entertainment building or a residential/retail building.

In an exemplary embodiment, the sports arena 18a is primarily used as a venue for sporting events, the building 18b is an office/retail building, the building 18c is a retail/entertainment building including restaurants, clubs and/or retail stores, the building 18h is a hotel, the building 18i is an office/retail building, the building 18k is a retail building, and each of the buildings 18m, 18p and 18r is a residential/retail building.

In an exemplary embodiment, as illustrated in FIG. 7, the plaza screens 48 are positioned in the vicinity of the plaza 18d. The tower screens 50 are positioned at one corner of the building 18c near the street 18e. The portal screen 52 is positioned at one end of the building 18b near the street 18e. The tall wall screen is 54 is positioned at one corner of the building 18h, near the corner of the streets 18g and 181. A kiosk 40 is positioned near the building 18b and the street 18g, near the building 18f and the street 18g, near the building 18c and the street 18e, at the corner of the streets 18e and 18j, near the building 18e and the street 18q, between the buildings 18h and 18i, near the building 18i at the corner of the streets 18j and 181, near the building 18k at the corner of the streets 18j and 181, across the street 18g from the building 18k, at the corner of the streets 18j and 18n, near the building 18m at the corner of the streets 18j and 18n, near the park 18o, at the corner of the streets 18n and 18q, and near the building 18r and the street 18q.

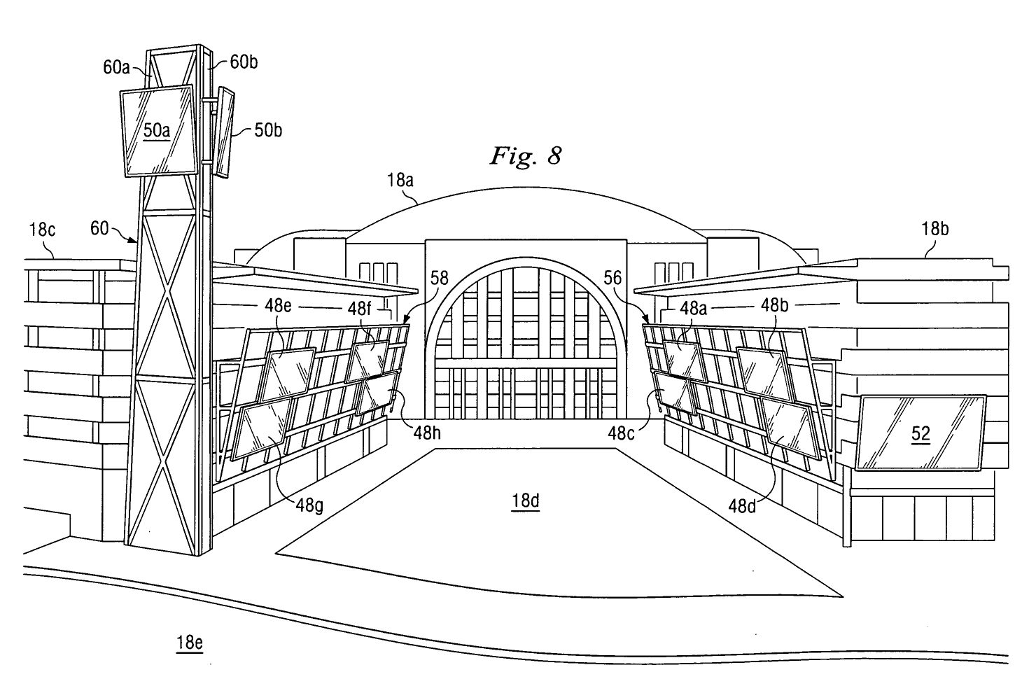

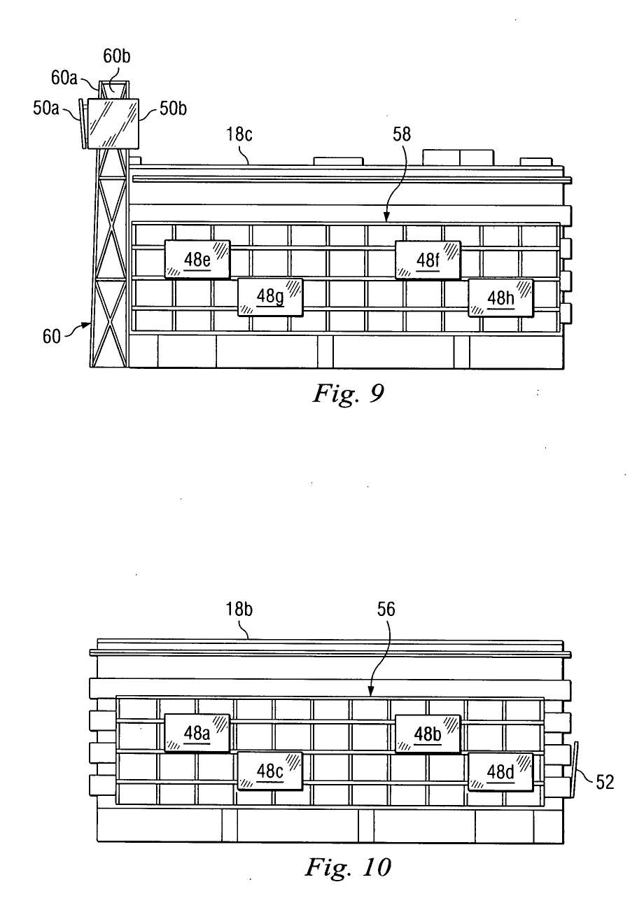

In an exemplary embodiment, as illustrated in FIGS. 8, 9 and 10, the plurality of plaza screens 48 includes plaza screens 48a, 48b, 48c, 48d, 48e, 48f, 48g and 48h. The plaza screens 48a, 48b, 48c and 48d are coupled to a frame 56, which, in turn, is coupled to the building 18b. The frame 56 is configured so that the plaza screens 48a, 48b, 48c and 48d are inclined, relative to the plaza 18d. The plaza screens 48a and 48b are vertically aligned and are movable horizontally, relative to the frame 56. That is, while remaining vertically aligned, the plaza screens 48a and 48b are adapted to move along the frame 56 towards, or away from, the arena 18a. The plaza screens 48c and 48d are vertically aligned and are movable horizontally, relative to the frame 56. In an exemplary embodiment, the frame 56 includes one or more horizontally-extending tracks, to which the plaza screens 48a, 48b, 48c and 48d are mounted in order to permit the horizontal movement of the screens 48a, 48b, 48c and 48d. In several exemplary embodiments, the horizontal movement of any one of the screens 48a, 48b, 48c and 48d is either synchronized with, or independent of, the horizontal movement of any one other of the screens 48a, 48b, 48c and 48d. In an exemplary embodiment, the range of horizontal movement for each of the screens 48a, 48b, 48c and 48d is 220 feet.

Similarly, the plaza screens 48e, 48f, 48g and 48h are coupled to a frame 58, which, in turn, is coupled to the building 18c. The frames 56 and 58 oppose each other so that the plaza screens 48e, 48f, 48g and 48h face the plaza screens 48a, 48b, 48c and 48d across the plaza 18d. The frame 58 is configured so that the plaza screens 48e, 48f, 48g and 48h are inclined, relative to the plaza 18d. The plaza screens 48e and 48f are vertically aligned and are movable horizontally, relative to the frame 58. The plaza screens 48g and 48h are vertically aligned and are movable horizontally, relative to the frame 58. In an exemplary embodiment, the frame 58 includes one or more horizontally-extending tracks, to which the plaza screens 48e, 48f, 48g and 48h are mounted in order to permit the horizontal movement of the screens 48e, 48f, 48g and 48h. In several exemplary embodiments, the horizontal movement of any one of the screens 48e, 48f, 48g and 48h is either synchronized with, or independent of, the horizontal movement of any one other of the screens 48e, 48f, 48g and 48h. In an exemplary embodiment, the range of horizontal movement for each of the screens 48e, 48f, 48g and 48h is 220 feet.

In several exemplary embodiments, the screens 48a, 48b, 48c, 48d, 48e, 48f, 48g and 48h are primarily visible from the plaza 18d of the urban space 18. In several exemplary embodiments, one or more of the screens 48a, 48b, 48c, 48d, 48e, 48f, 48g and 48h are at least partially visible from the streets 18e and/or 18g, other portions of the urban space 18, and/or portions of the environment surrounding the urban space 18.

In an exemplary embodiment, the plurality of tower screens 50 includes tower screens 50a and 50b. A tower 60 including sides 60a and 60b is positioned adjacent the building 18c, in the vicinity of the most populated and highly trafficked area of the urban space 18. In an exemplary embodiment, the tower 60 is about 120 feet tall. The screens 50a and 50b are coupled to the sides 60a and 60b, respectively, of the tower 60, and are positioned towards the top of the tower 60. The tower screens 50a and 50b are generally perpendicular to one another and therefore are visible from respective, generally-perpendicular directions, both within and outside of the urban space 18. Due to the location of the tower 60 and the positioning of the tower screens 50a and 50b on the tower 60, the tower screens 50a and 50b are adapted to provide a premier landmark identity and branding opportunity in the urban space 18.

In an exemplary embodiment, the portal screen 52 is coupled to an end of the building 18b so that the screen 52 faces the street 18e, the building 18h and/or the street 18g.

In an exemplary embodiment, although not shown, one or more elements of the theatrical lighting system 42 are coupled to each of the frames 56 and 58. In an exemplary embodiment, although not shown, one or more elements of the theatrical lighting system 42 are coupled to the tower 60. In an exemplary embodiment, although not shown, the speaker poles 46 are distributed across the plaza 18d. In an exemplary embodiment, although not shown, a row of spaced speaker poles 46 are distributed across the plaza 18d, in front of the frame 56, and another row of spaced speaker poles 46 are distributed across the plaza 18d, in front of the frame 58.

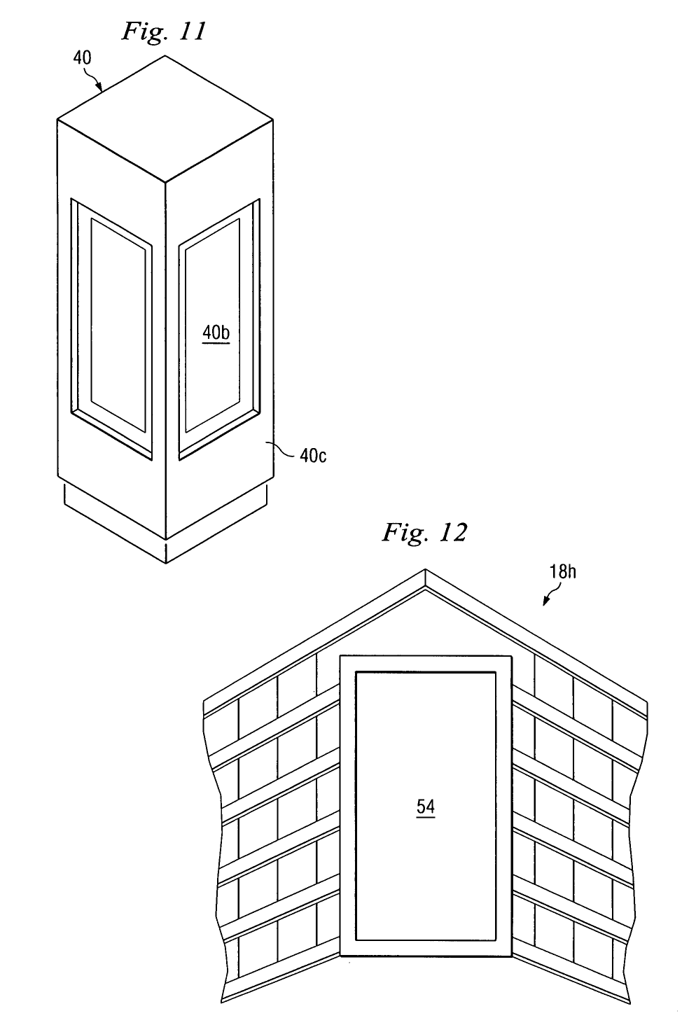

In an exemplary embodiment, as illustrated in FIG. 11, each kiosk 40 includes a structure 40c that houses and/or supports the respective kiosk speaker 40a (not shown) and the respective kiosk display 40b.

In an exemplary embodiment, as illustrated in FIG. 12, the tall wall screen 54 is mounted against the facade, or exterior, of a corner portion of the building 18h.

In operation, in an exemplary embodiment and with continuing reference to FIGS. 1-12, media is distributed, or broadcast, throughout the urban space 18 over the multimedia network 10. The network headend 16 controls and monitors the media elements 14, controllably routing video content to one or more of the display elements 26, audio content to one or more of the audio elements 24, and/or lighting cues to one or more of the lighting elements 22, via the network infrastructure 20, thereby creating an immersive multimedia environment within the urban space 18. In an exemplary embodiment, the video content, audio content and/or the lighting cues broadcast over the multimedia network 10 are stored in the memory 16b, and the processor 16a executes instructions stored in the memory 16b to controllably route the video content to the display elements 26, the audio content to the audio elements 24, and/or the lighting content or cues to the lighting elements 22, via the network infrastructure 20. In an exemplary embodiment, the video content routed to one or more display elements 26 may be identical to, similar to, or different than, the video content routed to one or more other display elements 26. In an exemplary embodiment, the audio content routed to one or more audio elements 24 may be identical to, similar to, or different than, the video content routed to one or more other audio elements 24. In an exemplary embodiment, the lighting cues routed to one or more lighting elements 22 may be identical to, similar to, or different than, the lighting cues routed to one or more other lighting elements 22. In several exemplary embodiments, the video content routed to the display elements 26 includes single-screen video content, single-stream video content, multiple-screen video content, multiple-stream video content, and/or any combination thereof. In several exemplary embodiments, the video content routed to any of the display elements 26 includes one or more static images, and/or one or more dynamic or moving images.

During its operation, the multimedia network 10 is centrally controlled. In an exemplary embodiment, and in contrast to providing unrelated, individually-controlled media elements that deliver a barrage of conflicting messages, the media elements 14 are centrally controlled by the network headend 16 via the network infrastructure 20. As a result, the network 10 is permitted to deliver a single integrated message, or a plurality of integrated, non-conflicting, consistent and/or unified messages, via the centrally-controlled media elements 14. As a result, the multimedia network 10 operates to integrate the entire geographic area or space defined by the urban space 18 into a consolidated and consistent media experience.

In an exemplary embodiment, during the above-described operation of the multimedia network 10, the tower screens 50a and 50b display video content and/or static images. In an exemplary embodiment, as noted above, the tower screens 50a and 50b provide landmark identity to the urban space 18, and provide branding opportunities for groups such as, for example, advertisers, corporate sponsors and/or non-profit organizations. In an exemplary embodiment, the tower screens 50a and 50b display video content and/or static images that may or may not be related, similar, or identical to the content being broadcast over the remainder of the media elements 14 of the multimedia network 10.

In an exemplary embodiment, during the above-described operation of the multimedia network 10, the portal screen 52 displays video content and/or static images. In an exemplary embodiment, the portal screen 52 provides key visibility to the plaza 18d, attracting and promoting activities occurring in the plaza 18d, such as the broadcasting of video content via one or more of the plaza screens 48a, 48b, 48c, 48d, 48e, 48f, 48g and 48h. In an exemplary embodiment, due to its positioning at the entry to the plaza 18d, the portal screen 52 provides a multitude of messaging opportunities to visitors to, and/or residents and/or tenants of, the urban space 18. In an exemplary embodiment, the portal screen 52 displays video content and/or static images that may or may not be related, similar, or identical to the content being broadcast over the remainder of the media elements 14 of the multimedia network 10.

In an exemplary embodiment, during the above-described operation of the multimedia network, the tall wall screen 54 displays video content and/or static images. In an exemplary embodiment, the tall wall screen 54 displays video content and/or static images that may or may not be related, similar, or identical to the content being broadcast over the remainder of the media elements 14 of the multimedia network 10.

In an exemplary embodiment, during the above-described operation of the multimedia network 10, each kiosk 40 displays video content via its kiosk screen 40b. Each kiosk 40 plays audio content via its kiosk speaker 40a, providing localized sound to enhance any message intended to be communicated via the respective kiosk 40 and/or the network 10. In an exemplary embodiment, each kiosk 40 displays video content and/or static images that may or may not be related, similar, or identical to the content being broadcast over the remainder of the media elements 14 of the multimedia network 10. In an exemplary embodiment, each kiosk 40 uses back-lit illumination to display one or more static images. In several exemplary embodiments, each kiosk 40 displays promotional content, directional signage and/or community announcements. In several exemplary embodiments, the kiosks 40 deliver high-circulation figures for messages due to the above-described curbside positioning of the kiosks 40 throughout the urban space 18, and their resulting proximity to pedestrians and automobile drivers and passengers in the urban space 18.

In an exemplary embodiment, during the above-described operation of the multimedia network 10, the plaza screens 48a, 48b, 48c, 48d, 48e, 48f, 48g and 48h display video content controllably routed thereto by the network headend 16 via the network infrastructure 20. Before, during and/or after the display of video content by the plaza screens 48a, 48b, 48c, 48d, 48e, 48f, 48g and 48h, the multi-channel surround system 44, including the speaker poles 46, broadcast audio content in the plaza 18d. Before, during or after the display of video content by the plaza screens 48a, 48b, 48c, 48d, 48e, 48f, 48g and 48h, the theatrical lighting system 42 broadcasts lighting effects across the plaza 18d.

As a result of the above-described broadcast of video content, audio content and/or lighting effects, an immersive multimedia environment is created in the plaza 18d of the urban space 18. In several exemplary embodiments, the network 10 is controlled so that the video content, audio content and lighting effects broadcast by the network 10 in the plaza 18d of the urban space 18 are carefully planned, choreographed and/or synchronized, thereby heightening the overall immersive multimedia environment in the plaza 18d. The opposing arrangement, across the plaza 18d, of the plaza screens 48a, 48b, 48c and 48d, and the plaza screens 48e, 48f, 48g and 48h, further heightens the overall immersive multimedia environment in the plaza 18d. As a result, visitors, guests and tenants of the urban space 18 that are relatively near, or in, the plaza 18d enjoy a multi-sensory, multi-dimensional experience.

In an exemplary embodiment, and as noted above, the plaza screens 48a, 48b, 48c and 48d are independently and horizontally movable along the frame 56, and the plaza screens 48e, 48f, 48g and 48h are independently and horizontally movable along the frame 58. In an exemplary embodiment, the network headend 16 controls the movement of each of the plaza screens 48a, 48b, 48c, 48d, 48e, 48f, 48g and 48h via the network infrastructure 20.

During the operation of the network 10, in an exemplary embodiment, as illustrated in FIG. 13 with continuing reference to FIGS. 1-12, the plaza screens 48a, 48b, 48c and 48d move together so that the screens 48a, 48b, 48c and 48d are adjacent one another and form a large-sized composite screen, or superscreen, with high-definition resolution. Similarly, the plaza screens 48e, 48f, 48g and 48h move together so that the screens 48e, 48f, 48g and 48h are adjacent one another and form a large-sized screen, or superscreen, with high-definition resolution.

During the operation of the network 10, in an exemplary embodiment, as illustrated in FIG. 13 with continuing reference to FIGS. 1-12, the plaza screens 48a, 48b, 48c and 48d move together, as a superscreen, along the plaza 18d and towards the arena 18a, stopping at an end of the frame 56 that is proximate the arena 18a. The plaza screens 48e, 48f, 48g and 48h mirror the movement of the plaza screens 48a, 48b, 48c and 48d, also moving along the plaza 18d and towards the arena 18a, stopping at an end of the frame 58 that is proximate the arena 18a. In an alternative exemplary embodiment, the plaza screens 48a, 48b, 48c and 48d may form a superscreen at the conclusion of their respective movements along the frame 56, and/or the plaza screens 48e, 48f, 48g and 48h may form a superscreen at the conclusion of their respective movements along the frame 58.

During the operation of the network 10, in an exemplary embodiment, as illustrated in FIG. 14 with continuing reference to FIGS. 1-13, the plaza screens 48a, 48b, 48c and 48d form a superscreen and are centered in the frame 56. The positions of the plaza screens 48e, 48f, 48g and 48h mirror the position of the plaza screens 48a, 48b, 48c and 48d, forming a superscreen and being centered in the frame 58.

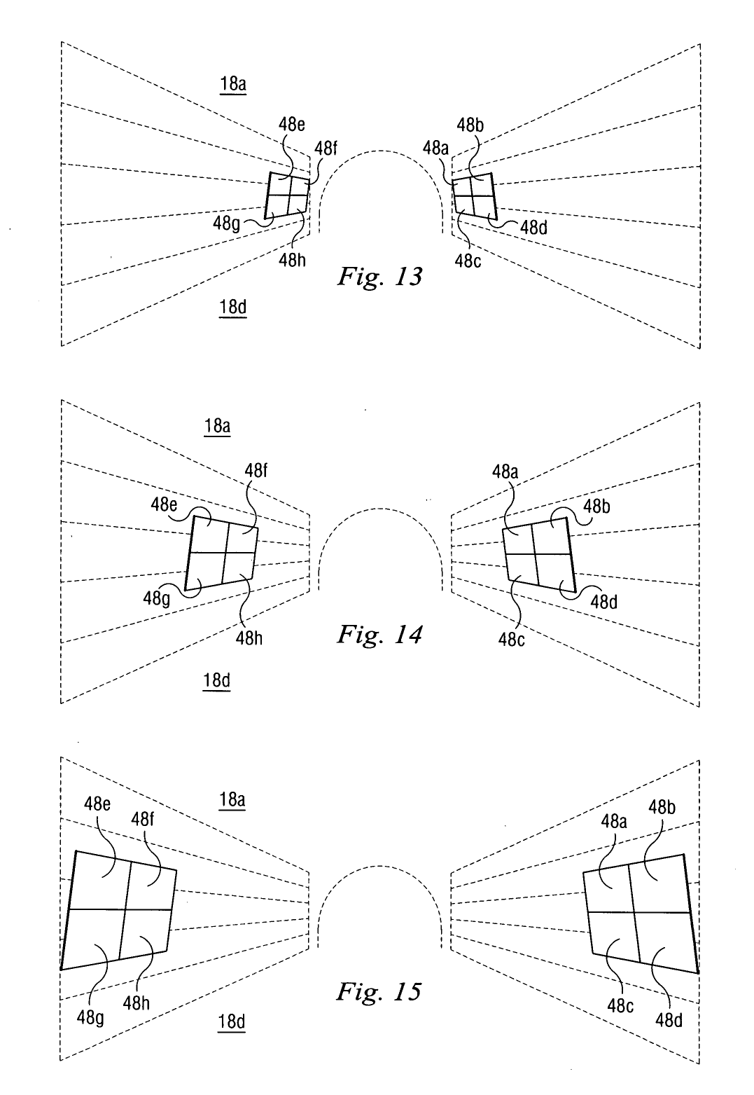

During the operation of the network 10, in an exemplary embodiment, as illustrated in FIG. 15 with continuing reference to FIGS. 1-14, the plaza screens 48a, 48b, 48c, 48d move together, as a superscreen, along the plaza 18d and away from the arena 18a, stopping at an end of the frame 56 that is proximate the street 18e. The plaza screens 48e, 48f, 48g and 48h mirror the movement of the plaza screens 48a, 48b, 48c and 48d, also moving along the plaza 18d and away from the arena 18a and stopping at an end of the frame 58 that is proximate the street 18e. In an alternative exemplary embodiment, the plaza screens 48a, 48b, 48c and 48d may form a superscreen at the conclusion of their respective movements along the frame 56, and/or the plaza screens 48e, 48f, 48g and 48h may form a superscreen at the conclusion of their respective movements along the frame 58.

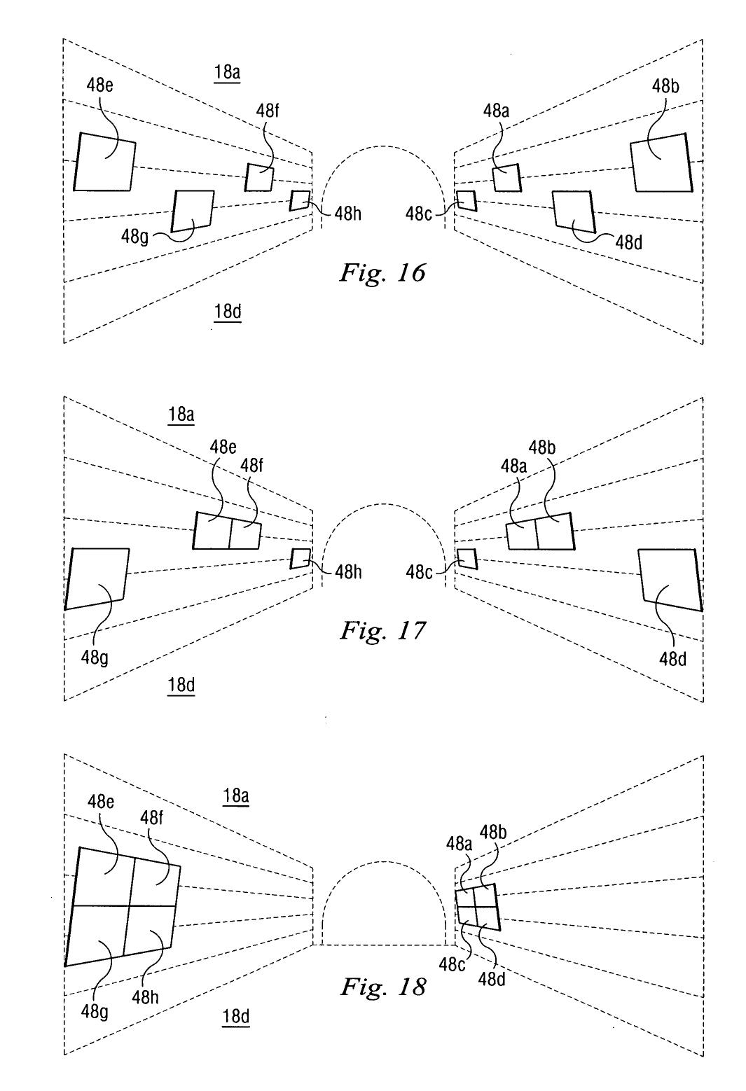

During the operation of the network 10, in an exemplary embodiment, as illustrated in FIG. 16 with continuing reference to FIGS. 1-15, the plaza screens 48a, 48b, 48c and 48d are moved so that the screens are separated and positioned in a staggered configuration. The arrangement of the plaza screens 48e, 48f, 48g and 48h mirrors the arrangement of the plaza screens 48a, 48b, 48c and 48d.

During the operation of the network 10, in an exemplary embodiment, as illustrated in FIG. 17 with continuing reference to FIGS. 1-16, the plaza screens 48a, 48b, 48c and 48d are moved so that the screens are separated and positioned in another staggered configuration. The arrangement of the plaza screens 48e, 48f, 48g and 48h mirrors the arrangement of the plaza screens 48a, 48b, 48c and 48d.

During the operation of the network 10, in an exemplary embodiment, as illustrated in FIG. 18 with continuing reference to FIGS. 1-17, the plaza screens 48a, 48b, 48c and 48d move together, as a superscreen, along the plaza 18d and towards the arena 18a, stopping at an end of the frame 56 that is proximate the arena 18a. The plaza screens 48e, 48f, 48g and 48h move in the opposite direction, moving along the plaza 18d and away the arena 18a, stopping at an end of the frame 58 that is proximate the street 18e.

During the operation of the network 10, in an exemplary embodiment, as illustrated in FIG. 19 with continuing reference to FIGS. 1-18, the plaza screens 48a, 48b, 48c and 48d move together, as a superscreen, along the plaza 18d and away from the arena 18a, stopping at an end of the frame 56 that is proximate the street 18e. The plaza screens 48e, 48f, 48g and 48h move in the opposite direction, moving along the plaza 18d and towards the arena 18a, stopping at an end of the frame 58 that is proximate the arena 18a.

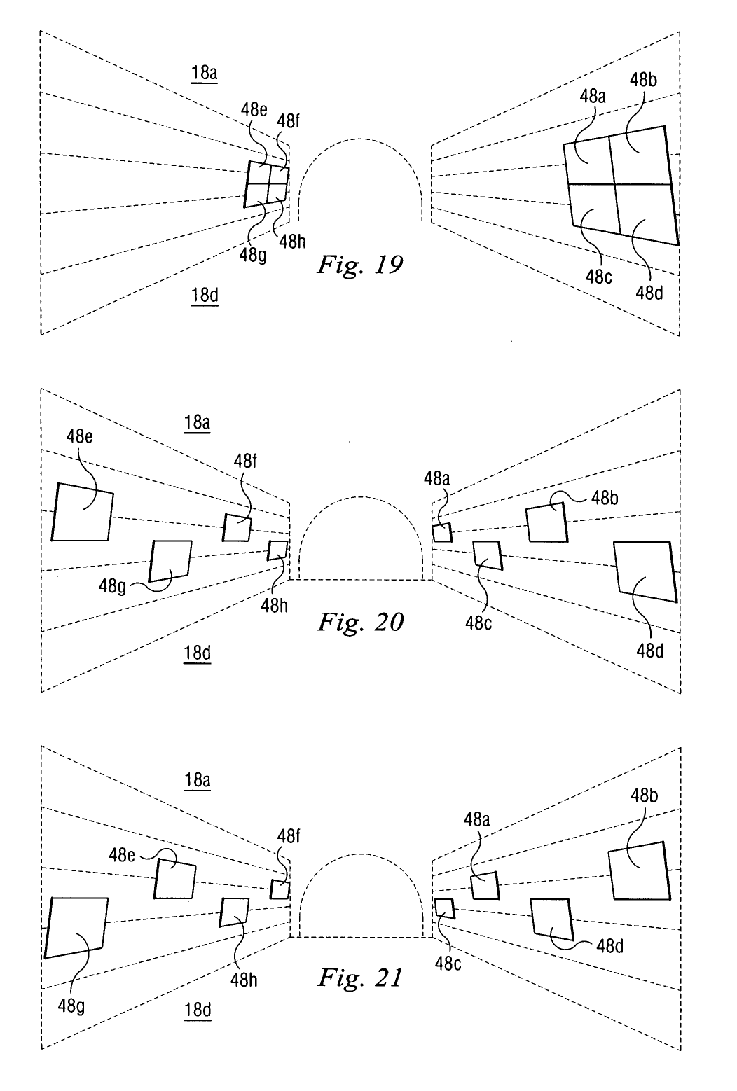

During the operation of the network 10, in an exemplary embodiment, as illustrated in FIG. 20 with continuing reference to FIGS. 1-19, the plaza screens 48a, 48b, 48c and 48d are moved so that the screens are separated and positioned in yet another staggered configuration. The arrangement of the plaza screens 48e, 48f, 48g and 48h does not mirror the arrangement of the plaza screens 48a, 48b, 48c and 48d.

During the operation of the network 10, in an exemplary embodiment, as illustrated in FIG. 21 with continuing reference to FIGS. 1-20, the plaza screens 48a, 48b, 48c and 48d are moved so that the screens are separated and positioned in the staggered configuration depicted in FIG. 16. However, the arrangement of the plaza screens 48e, 48f, 48g and 48h does not mirror the arrangement of the plaza screens 48a, 48b, 48c and 48d.

During the operation of the network 10, in several exemplary embodiments, the independent-movement capability of each of the plaza screens 48a, 48b, 48c, 48d, 48e, 48f, 48g and 48h allow for a myriad of configurations and/or motion possibilities.

During the operation of the network 10, in an exemplary embodiment, instead of, or in addition to the foregoing, one or more of the plaza screens 48a, 48b, 48c, 48d, 48e, 48f, 48g and 48h display static images. In an exemplary embodiment, the plaza screens 48a, 48b, 48c, 48d, 48e, 48f, 48g and 48h display video content and/or static images that may or may not be related, similar, or identical to the content being broadcast over the remainder of the media elements 14 of the multimedia network 10.

During the operation of the network 10, in several exemplary embodiments, the input elements 12 permit visitors, guests and tenants of the urban space 18 to passively and/or actively interact with, and/or effect changes in, the content and/or messages broadcast over the network 10.

In an exemplary embodiment, during the operation of the network 10, visitors, guests and/or tenants of the urban space 18 use the input elements 12 to send input signals to the network headend 16 via the network infrastructure 20. In an exemplary embodiment, the network headend 16 receives the input signals from the input elements 12, conditions/processes the input signals, and routes content to one or more of the media elements 14, and/or changes the content being broadcast over one or more of the media elements, in response to the input signals. As a result, an interactive multimedia environment is created by the network 10.

In an exemplary embodiment, during the operation of the network 10, visitors, guests and/or tenants of the urban space 18 use the cellular telephones 30 and/or telephones 38 to send text messages, upload content, participate in contests, call certain telephone numbers and/or push certain buttons on the telephones 30 and/or 38. In response to the use of the cellular telephones 30 and/or 38, signals are transmitted to the network headend 60 via the network infrastructure 20. In response, the network headend 16 routes content to one or more of the media elements 14, and/or changes the content being broadcast over one or more of the media elements 14. As a result, an interactive multimedia environment is created by the network 10.

In an exemplary embodiment, during the operation of the network 10, visitors, guests and/or tenants of the urban space 18 use the web browsers 32 and/or PDAs 34 to, for example, send e-mail messages, upload content, participate in contests, and/or access and interact with websites. In response to the use of the web browsers 32 and/or PDAs 34, signals are transmitted to the network headend 60 via the network infrastructure 20. In response, the network headend 16 transmits or routes content to one or more of the media elements 14, and/or changes the content being broadcast over one or more of the media elements 14. As a result, an interactive multimedia environment is created by the network 10.

In an exemplary embodiment, during the operation of the network 10, visitors, guests and/or tenants of the urban space 18 provide audio input to the audio transmitters 38. In response, the audio transmitters 38 transmit signals to the network headend 16 via the network infrastructure 20. In response, the network headend 16 transmits or routes content to one or more of the media elements 14, and/or changes the content being broadcast over one or more of the media elements 14. As a result, an interactive multimedia environment is created by the network 10.

In an exemplary embodiment, during the operation of the network 10, persons in the plaza 18d of the urban space 18 cheer in order to provide audio input to the audio transmitters 38. As the volume of the cheer increases, the video content displayed on one or more of the plaza screens 48a, 48b, 48c, 48d, 48e, 48f, 48g and 48h changes by, for example, displaying larger and larger moving and/or static images. As a result, an interactive multimedia environment is created by the network 10.

In an exemplary embodiment, during the operation of the network 10, sensors in the kiosks 40 sense the movement, noise level and/or other characteristics of persons in the vicinity of, or walking by, the kiosks 40. In response, the kiosk 40 sends signals to the network headend 16 via the network structure 20. In response, the network headend 16 transmits or routes content to one or more of the media elements 14, and/or changes the content being broadcast over one or more of the media elements 14. As a result, an interactive multimedia environment is created by the network 10. In several exemplary embodiments, one or more of the input elements 12 include sensors, which may be similar or identical to the sensors in the kiosks 40, and the input elements 12 may be distributed throughout the urban space 18, including throughout the plaza 18d, to create an interactive multimedia environment.

In an exemplary embodiment, before, during and/or after the above-described operation of the multimedia network 10, the network infrastructure 12 provides ready access to power and high-speed data connections, and wireless data connectivity to visitors, guests and tenants of the urban space 18. In an exemplary embodiment, before, during and/or after the above-described operation of the multimedia network 10, the network infrastructure 12 provides wireless network access including, for example, wireless Internet access, to visitors, guests and tenants of the urban space 18. In several exemplary embodiments, power and high-speed data connections, wireless data connectivity and/or wireless network access may be provided via one or more of the kiosks 40.

In several exemplary embodiments, the broadcast of content over the network 10, throughout the urban space 18, lengthens the stay of visitors and guests in the urban space 18, thereby potentially increasing the sales revenues of one or more tenants of one or more of the buildings in the urban space 18.

In an exemplary embodiment, the content broadcast over the multimedia network 10 is similar to a lifestyle television network, offering a lifestyle-magazine approach mix of entertainment, educational, informational, cultural and community-related content. In an exemplary embodiment, the content broadcast over the multimedia network 10 is relevant and engaging, and includes educational, informational, entertainment, cultural and community-related content. Examples of informational content broadcast over the network 10 include international news, national news, local news, weather, sports, local traffic, business news, and/or local stories of interest presented by, for example, a national-network affiliate. Examples of community-related content include cause promotion, information on upcoming local and community events, information on or related to local schools including upcoming school events, and/or information on or related to local non-profit organizations. Examples of cultural content broadcast over the network 10 include content related to cultural events in the space 18, the environment surrounding the space 18, and/or the city, state or country in which the space 18 is positioned.

In several exemplary embodiments, entertainment and/or cultural content broadcast over the network 10 include visual candy and/or digital fine artwork. In an exemplary embodiment, the digital fine artwork broadcast over the network 10 encompasses four categories: digital art, visual storytelling, film shorts, and interactive and performance art. Examples of digital art include fine art, graphic and media arts, video art, text art, VJ/Mash-up art such as, for example, a video that is edited from more than one source to appear as one, and/or any combination thereof. Examples of visual storytelling include digital animation, hand-drawn animation, and/or any combination thereof. Examples of film shorts include documentaries, fictional film shorts, journalistic film shorts, and/or any combination thereof. Examples of interactive and performance art include interactive multimedia, performance-based art, virtual (three-dimensional) environments, and/or any combination thereof.

In an exemplary embodiment, the content broadcast over the multimedia network 10 is time-dependent, reflecting changes in the people and/or vehicle traffic in the urban space 18 throughout the day. For example, the content broadcast over the multimedia network 10 may move from informational content to cultural content to entertainment content.

In several exemplary embodiments, instead of, in addition to, and/or in combination with the foregoing, the content broadcast over the multimedia network 10 includes advertisements or advertising-type content, marketing content, branded content, commercially-sponsored content, and/or any combination thereof. By broadcasting branded content over the network 10, the network 10 empowers the brand presented in the content, permitting the brand to be communicated in a fully customizable and immersive environment and allowing visitors to the space 18 to absorb and, in some exemplary embodiments, interact with the brand's messaging. In several exemplary embodiments, the branded and/or commercially-sponsored content is divided into consumer categories such as, for example, consumer electronics, financial, fashion, automobile, and other consumer categories. In an exemplary embodiment, an advertiser, such as a corporate partner or sponsor, purchases an exclusive sponsorship of a consumer category, such as one of the aforementioned consumer categories.

In an exemplary embodiment, the financial model of the multimedia network 10 is based on sponsorship revenue, including revenues generated in response to the above-described broadcast of advertisements or advertising-type content, marketing content, branded content, commercially-sponsored content, and/or any combination thereof, over the multimedia network 10. In an exemplary embodiment, the multimedia network 10 is underwritten by exclusive corporate partners who have the opportunity to advertise and market their goods and/or services by broadcasting content over the network 10.

In an exemplary embodiment, in addition to broadcasting branded and/or commercially-sponsored content over the multimedia network 10, an advertiser integrates the messages contained in the branded content with advertising associated with other activities occurring in the urban space 18 such as, for example, live events, press events, interior and exterior floor displays, art and collections exhibits, hospitality and banquet events, product display and sampling launches, and/or any combination thereof.

In several exemplary embodiments, the video content displayed by one or more of the plaza screens 48a, 48b, 48c, 48d, 48e, 48f, 48g and 48h, and/or the audio content played by the surround-system 44 are tailored to, and/or synchronized with, the movement of one or more of the plaza screens 48a, 48b, 48c, 48d, 48e, 48f, 48g and 48h. For example, the video content displayed by the plaza screens 48a, 48b, 48c, 48d, 48e, 48f, 48g and 48h may include a tennis match, with one player displayed on one or more of the screens 48a, 48b, 48c and 48d on one side of the plaza 18d, and the opposing player displayed on one or more of the screens 48e, 48f, 48g and 48h on the other side of the plaza 18d. When the players move, one or more of the plaza screens 48a, 48b, 48c and 48d, and one or more of the plaza screens 48e, 48f, 48g and 48h, move along with the respective players.

In an exemplary embodiment, the network 10 operates in the above-described manner continuously, twenty-four hours a day, seven days a week. In an exemplary embodiment, the network 10 operates in the above-described manner during one or more portions of a day. In an exemplary embodiment, the network 10 operates in the above-described manner for approximately 14-16 hours per day.

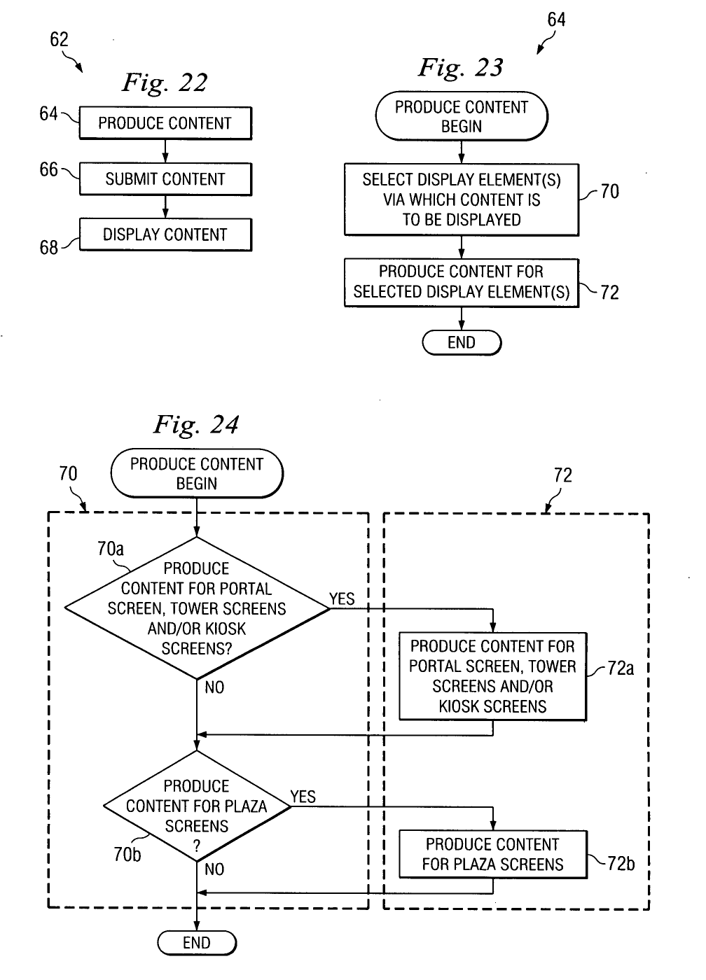

In an exemplary embodiment, as illustrated in FIG. 22 with continuing reference to FIGS. 1-21, a method is generally referred to by the reference numeral 62 and includes producing content for the multimedia network 10 in step 64, submitting the content in step 66 and displaying the content over the multimedia network 10 in step 68. In an exemplary embodiment, the processor 16a of the network headend 16 implements the method 62, or one or more steps thereof, by executing a plurality of instructions stored in the memory 16b. In several exemplary embodiments, one or more nodes such as, for example, one or more computers, one or more computing devices, one or more computer systems, one or more processors, and/or any combination thereof, implement the method 62, or one or more steps thereof, by executing a plurality of instructions stored in a computer readable medium or memory, which is a part of and/or operably coupled to the one or more nodes. In several exemplary embodiments, the method 62 is implemented by one or more nodes operably coupled to the network headend 16 via the network infrastructure 20. In several exemplary embodiments, the method 62 is implemented by one or more of the input elements 12.

In an exemplary embodiment, as illustrated in FIG. 23 with continuing reference to FIGS. 1-22, to execute the step 64 of the method 62, the display elements 26 of the multimedia network 10, via which the content is to be displayed, are selected in step 70. After the step 70, the content for the display elements 26 selected in the step 70 is produced in step 72.

In an exemplary embodiment, as illustrated in FIG. 24 with continuing reference to FIGS. 1-23, to execute the step 70, it is determined in step 70a whether content is to be produced for display over the portal screen 52, the tower screens 50a and 50b and/or the kiosk screens 40b. Moreover, it is determined in step 70b whether content is to be produced for display over the plaza screens 48a, 48b, 48c, 48d, 48e, 48f, 48g and/or 48h. To execute the step 72, if it is determined in the step 70a that content is to be produced for display over the portal screen 52, the tower screens 50a and/or 50b and/or the kiosk screens 40b, then the content for the portal screen 52, the tower screens 50a and/or 50b and/or the kiosk screens 40b is produced in step 72a. If it is determined in the step 70b that content is to be produced for display over the plaza screens 48a, 48b, 48c, 48d, 48e, 48f, 48g and/or 48h, then content for the plaza screens 48a, 48b, 48c, 48d, 48e, 48f, 48g and/or 48h is produced in step 72b.

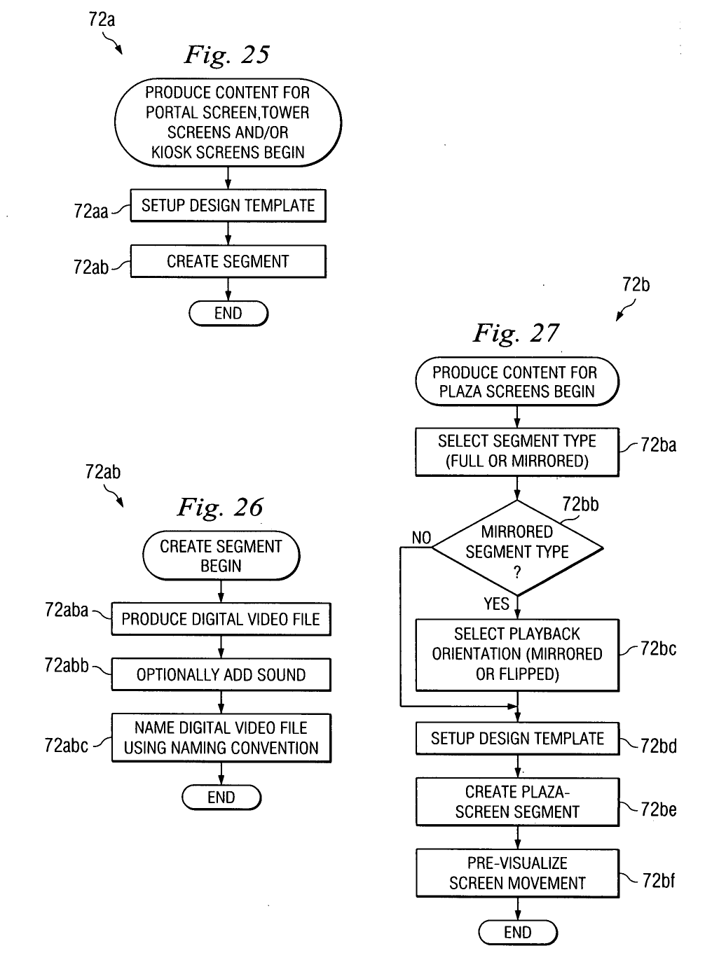

In an exemplary embodiment, as illustrated in FIG. 25 with continuing reference to FIGS. 1-24, to execute the step 72a to produce content for the portal screen 52, the tower screens 50a and/or 50b and/or the kiosk screens 40b, a design template is set up in step 72aa, which includes determining the overall canvas size or sizes for the content. In an exemplary embodiment, for content to be displayed by the portal screen 52, the overall canvas size is 1920 pixels wide by 1080 pixels high. In an exemplary embodiment, for content to be displayed by the portal screen 52, the overall canvas size is 968 pixels wide by 544 pixels high. In an exemplary embodiment, for content to be displayed by the tower screen 50a or 50b, the overall canvas size is 594 pixels wide by 576 pixels high. In an exemplary embodiment, for content to be displayed by the kiosk screens 40b, the overall canvas size is 1080 pixels wide by 1920 pixels high.

After the design template is set up in the step 72aa, a content segment is created in step 72ab. In several exemplary embodiments, a content segment refers to a piece of video content, which may potentially be of any length. In an exemplary embodiment, the time length of the content segment created in the step 72ab is 10 minutes. In several exemplary embodiments, the time length of the content segment created in the step 72ab is 0:15, 0:30, 1:00, 2:00 or 4:00.

In an exemplary embodiment, as illustrated in FIG. 26 with continuing reference to FIGS. 1-25, to execute the step 72ab, a digital video file is produced in step 72aba. In several exemplary embodiments, to produce the digital video file in the step 72aba, one or more digital video production tools are used such as, for example, Adobe AfterEffects, Apple Final Cut Pro, Premiere, Maya, Motion, other compositing tools, other animation tools, and/or any combination thereof. In an exemplary embodiment, the digital video file produced in the step 72aba is produced using the color depth “millions of colors.” Before, during or after the step 72aba, in an exemplary embodiment, sound is optionally added in step 72abb. Before, during or after the step 72aba, the video file is named using a naming convention in step 72abc. In an exemplary embodiment, the naming convention is:
<TITLE>_<SCREEN TYPE>.mov
   In an exemplary embodiment, the <TITLE> field is up to seven (7) characters long. In an exemplary embodiment, the <SCREEN TYPE> field is one character that identifies the type of screen on which the video content in the digital video file will be displayed. In an exemplary embodiment, the <SCREEN TYPE> field is K for display over the kiosk screens 40b, T for display over the tower screen 50a and/or 50b, and P for display over the portal screen 52. In an exemplary embodiment, if the video file is to be delivered as a frame sequence, the naming convention includes a zero padded index with the number of digits dictated by the length of the sequence; as a result, the naming convention is:

<TITLE> _<SCREEN TYPE>00001.TGA
<TITLE> _<SCREEN TYPE>00002.TGA
etc.

In an exemplary embodiment, the <TITLE> field is up to seven (7) characters long. In an exemplary embodiment, the <SCREEN TYPE> field is one character that identifies the type of screen on which the video content in the digital video file will be displayed. In an exemplary embodiment, the <SCREEN TYPE> field is K for display over the kiosk screens 40b, T for display over the tower screen 50a and/or 50b, and P for display over the portal screen 52.

In an exemplary embodiment, as illustrated in FIG. 27 with continuing reference to FIGS. 1-26, to execute the step 72b to produce content for the plaza screens 48a, 48b, 48c, 48d, 48e, 48f, 48g and/or 48h, the content segment type is selected in step 72ba. In an exemplary embodiment, the content segment type is selected in the step 72ba by selecting either a Full segment or a Mirrored segment. A Full segment is a segment according to which content is designed differently between the plaza screens 48 mounted on the frame 56, that is, the plaza screens 48a, 48b, 48c and 48d, and the plaza screens 48 mounted on the frame 58, that is, the plaza screens 48e, 48f, 48g and 48h. For a Full segment, two segments are produced. A Mirrored segment is a segment according to which the content produced for the plaza screens 48a, 48b, 48c and 48d is produced once, and then also used for the plaza screens 48e, 48f, 48g and 48h.

After the step 72ba, it is determined in step 72bb whether the segment type selected in the step 72ba is a Mirrored segment. If so, then the playback orientation of the Mirrored segment is selected in step 72bc.

In an exemplary embodiment, the playback orientation of the Mirrored segment is selected in the step 72bc by selecting either a mirrored playback orientation or a flipped playback orientation. A mirrored playback orientation is a playback orientation in which, during the above-described operation of the multimedia network 10, the plaza screens 48a, 48b, 48c and 48d move in the same direction as the plaza screens 48e, 48f, 48g and 48h. An example of the plaza screens 48a, 48b, 48c, 48d, 48e, 48f, 48g and 48h having undergone mirrored playback orientation is shown in FIG. 13, which depicts all of the plaza screens 48a, 48b, 48c, 48d, 48e, 48f, 48g and 48h having moved in the same direction, that is, towards the arena 18a and away from the street 18e. Another example of the plaza screens 48a, 48b, 48c, 48d, 48e, 48f, 48g and 48h having undergone mirrored playback orientation is shown in FIG. 15, which depicts all of the plaza screens 48a, 48b, 48c, 48d, 48e, 48f, 48g and 48h having moved in the same direction, that is, away from the arena 18a and towards the street 18e. A flipped playback orientation is a playback orientation in which, during the above-described operation of the network 10, the plaza screens 48a, 48b, 48c and 48d move in a direction opposite the direction of movement of the plaza screens 48e, 48f, 48g and 48h. An example of the plaza screens 48a, 48b, 48c, 48d, 48e, 48f, 48g and 48h having undergone flipped playback orientation is shown in FIG. 18, which depicts the plaza screens 48a, 48b, 48c and 48d having moved towards the arena 18a, and the plaza screens 48e, 48f, 48g and 48h having moved in the opposite direction, that is, away from arena 18a. Another example of the plaza screens 48a, 48b, 48c, 48d, 48e, 48f, 48g and 48h having undergone flipped playback orientation is shown in FIG. 19, which depicts the plaza screens 48a, 48b, 48c and 48d having moved away from the arena 18a, and the plaza screens 48e, 48f, 48g and 48h having moved in the opposite direction, that is, towards the arena 18a.

In step 72bd, a design template is set up. In an exemplary embodiment, setting up the design template in the step 72bd includes determining the overall canvas size for the content. In an exemplary embodiment, the video content for the plaza screens 48a, 48b, 48c and 48d is created as one large video segment, regardless of whether the plaza screens 48a, 48b, 48c and 48d are combined to form a superscreen, or always remain separated, during the operation of the network 10. In an exemplary embodiment, for the content to be displayed on the plaza screens 48a, 48b, 48c and 48d, the overall composite canvas size is 1920 pixels wide by 1080 pixels high (standard High Definition). In an exemplary embodiment, the design template accommodates a 7-pixel gap in between the plaza screens 48a, 48b, 48c and 48d. In an exemplary embodiment, for the content to be displayed on the plaza screens 48a, 48b, 48c and 48d, the overall composite canvas size is 1589 pixels wide by 901 pixels high. In an exemplary embodiment, the design template accommodates a 5-pixel gap in between the plaza screens 48a, 48b, 48c and 48d. In an exemplary embodiment, the video content for the plaza screens 48e, 48f, 48g and 48h is created as one large video segment, regardless of whether the plaza screens 48e, 48f, 48g and 48h are combined to form a superscreen, or always remain separated, during the operation of the network 10. In an exemplary embodiment, for the content to be displayed on the plaza screens 48e, 48f, 48g and 48h, the overall composite canvas size is 1920 pixels wide by 1080 pixels high (standard High Definition). In an exemplary embodiment, the design template accommodates a 7-pixel gap in between the plaza screens 48e, 48f, 48g and 48h. In an exemplary embodiment, for the content to be displayed on the plaza screens 48e, 48f, 48g and 48h, the overall composite canvas size is 1589 pixels wide by 901 pixels high. In an exemplary embodiment, the design template accommodates a 5-pixel gap in between the plaza screens 48e, 48f, 48g and 48h.

After the design template has been set up in the step 72bd, the video content for the plaza screens 48a, 48b, 48c, 48d, 48e, 48f, 48g and 48h is created in step 72be. After the step 72be, the movement of the plaza screens 48a, 48b, 48c, 48d, 48e, 48f, 48g and 48h is optionally pre-visualized in step 72bf. In an exemplary embodiment, to execute the step 72bf, a computer program is downloaded from one or more nodes and includes a simulator that permits the pre-visualization of the coordination between the video content for the plaza screens 48a, 48b, 48c, 48d, 48e, 48f, 48g and 48h, and the programmed motion commands for the plaza screens 48a, 48b, 48c, 48d, 48e, 48f, 48g and 48h. In an exemplary embodiment, the computer program includes several screen settings corresponding to point-in-time positions of the movable plaza screens 48a, 48b, 48c, 48d, 48e, 48f, 48g and 48h. In an exemplary embodiment, a plurality of screen settings are included in the computer program that correspond to the positions of the plaza screens 48a, 48b, 48c, 48d, 48e, 48f, 48g and 48h shown in FIGS. 13, 14, 15, 16 and 17. By combining the video content and one or more of the screen settings, the synchronization of the video content and the planned movement of the plaza screens 48a, 48b, 48c, 48d, 48e, 48f, 48g and 48h is simulated and pre-visualized in the step 72bf. In response to the pre-visualization in the step 72bf, adjustments and/or changes to the video content and/or the programmed motion commands of one or more of the plaza screens 48a, 48b, 48c, 48d, 48e, 48f, 48g and 48h can be made to improve and/or optimize the coordination between the video content and the motion of the plaza screens 48 before the video content is broadcast over the network 10.

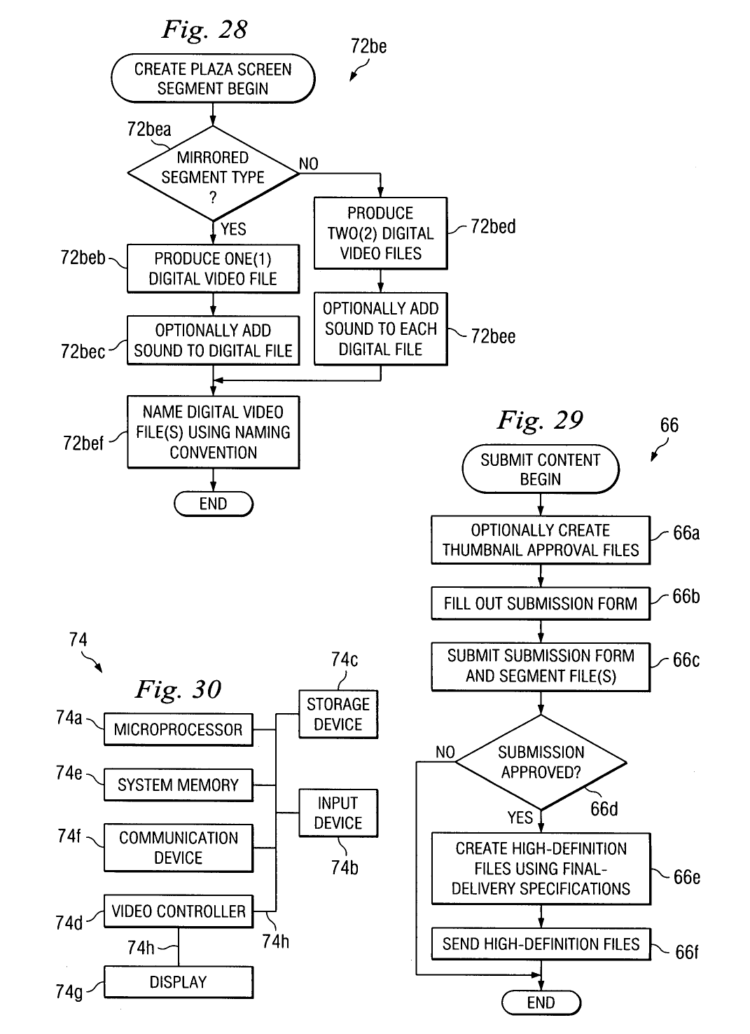

In an exemplary embodiment, as illustrated in FIG. 28 with continuing reference to FIGS. 1-27, to execute the step 72be to create the video content for the plaza screens 48a, 48b, 48c, 48d, 48e, 48f, 48g and 48h, it is determined in step 72bea whether the segment type selected in the step 72ba is a Mirrored segment. If so, then one (1) digital video file is produced in step 72beb. In several exemplary embodiments, to produce the digital video file in the step 72beb, one or more digital video production tools are used such as, for example, Adobe AfterEffects, Apple Final Cut Pro, Premiere, Maya, Motion, other compositing tools, other animation tools, and/or any combination thereof. Before, during or after the step 72beb, in an exemplary embodiment, sound is optionally added in step 72bec.

If it is determined in the step 72beb that the segment type is not a Mirrored segment, but instead is a Full segment, then two (2) digital video files are created in step 72bed. In several exemplary embodiments, to produce the digital video files in the step 72bed, one or more digital video production tools are used such as, for example, Adobe AfterEffects, Apple Final Cut Pro, Premiere, Maya, Motion, other compositing tools, other animation tools, and/or any combination thereof. In an exemplary embodiment, the digital video file produced in the step 72bed is produced using the color depth “millions of colors.” Before, during or after the step 72bed, in an exemplary embodiment, sound is optionally added in step 72bee.

Before, during or after the step 72beb or 72bed, the video file or files are named using a naming convention in step 72bef. In an exemplary embodiment, the naming convention is:
<TITLE>_<SEGMENT TYPE>.mov
   In an exemplary embodiment, the <TITLE> field is up to seven (7) characters long. In an exemplary embodiment, the <SEGMENT TYPE> field is one character that identifies the segment type. In an exemplary embodiment, the <SEGMENT TYPE> field is 1 for a Full segment, and 2 for a Mirrored segment. In an exemplary embodiment, the naming convention is:
<TITLE>_<SCREEN SET>.mov
   In an exemplary embodiment, the <SCREEN SET> field is a numeric character that designates the set of plaza screens 48 on which the video content in the digital video file will be displayed. In an exemplary embodiment, the <SCREEN SET> field is “1” when the video content in the digital video file is to be displayed over the plaza screens 48a, 48b, 48c and 48d, and the <SCREEN SET> field is “2” when the video content in the digital video file is to be displayed over the plaza screens 48e, 48f, 48g and 48h. In an exemplary embodiment, the <TITLE> field is up to seven (7) characters long. In an exemplary embodiment, if the video file is to be delivered as a frame sequence, the naming convention includes a zero padded index with the number of digits dictated by the length of the sequence; as a result, the naming convention is:

00001<TITLE>_<SCREEN SET>.TGA
00002<TITLE>_<SCREEN SET>.TGA
etc.

In several exemplary embodiments, one or more of the content segments created in the steps 72ab and/or 72be are grouped together to form blocks of video content. In an exemplary embodiment, each block of video content is ten minutes in length. In an exemplary embodiment, each block of video content includes a unique creative personality. In several exemplary embodiments, the blocks of video content are grouped into packages of video content. In an exemplary embodiment, each package of video content is one hour in length. In an exemplary embodiment, each package of video content includes a unique mood and audience objective. In several exemplary embodiments, a single block of video content may be included in different packages of video content at different times during the operation of the network 10.

In an exemplary embodiment, and as noted above, the content produced in the step 64 is submitted in the step 66.

In an exemplary embodiment, as illustrated in FIG. 29 with continuing reference to FIGS. 1-28, in the step 66, thumbnail approval files are optionally created in step 66a.

In an exemplary embodiment, if the portal screen 52, the tower screens 50a and/or 50b, the kiosk screens 40b, and/or any combination thereof, are selected in the step 70 as the display elements 26 via which the content is to be displayed, then optionally creating thumbnail approval files in the step 66a includes rendering the video files produced in the step 72aba in Quicktime file format, at half-resolution, and at 15 frames per second.

In an exemplary embodiment, if the plaza screens 48a, 48b, 48c, 48d, 48e, 48f, 48g, 48h, and/or any combination thereof, are selected in the step 70 as the display elements 26 via which the content is to be displayed, then optionally creating thumbnail approval files in the step 66a includes rendering the video files produced in the step 72beb or 27bed using a composite format, that is, four (4) videos in each file produced, in Quicktime file format, at 794 pixels×450 pixels, and at no higher than 15 frames per second.

In an exemplary embodiment, whether the thumbnail files are created in the step 66a is dependent upon the submitter of the content. In an exemplary embodiment, if the submitter of the content is an individual artist and/or an artists' group, then the thumbnail approval files are created in the step 66a.

In step 66b, a submission form is filled out. In an exemplary embodiment, the submission formed filled out in the step 66b includes an artist-contact-information section, a description-of-the-submission section, and a brief-biography-of-the-artist section. In several exemplary embodiments, the artist-contact-information section includes areas for one or more of the following: first name, last name, role in production of submission, street address, city, state, zip code, country, e-mail address, telephone number (day and evening), facsimile number, and URL of work on the World Wide Web. In several exemplary embodiments, the description-of-the-submission section includes areas for one or more of the following: title of artwork, file type, original format, format submitted, length (in minutes), sound availability, information on the residence of one or more of the filmmakers or producers of the submission, information on the location of the production of the submission, and other publications, festivals and/or awards for artwork contained in the submission. In an exemplary embodiment, the submission form filled out in the step 66b includes a terms section in which, for example, the submitter acknowledges and agrees that all materials in the submission are original to the submitter and the submitter has all rights in the submission, except as expressly noted by the submitter, that the owner and/or operator the network 10 will become the owners of the materials submitted, that the owner and/or operator of the network 10 has no obligation to broadcast the content in the submission over the network 10 or otherwise, that the owner and/or operator of the network 10 has no liability to the submitter for other artwork in other submissions that may include ideas or concepts similar to the content in the submission, that the owner and/or operator of the network 10 has no obligation to keep the content of the submission or its ideas or concepts in confidence, that if the owner and/or operator of the network 10 decides to broadcast the content contained in the submission over the network 10, then the submitter will be required to agree to additional terms and conditions before the content in the submission is broadcast or displayed.

In step 66c, the submission form filled out in the step 66b and one or more of the files created in the steps 72aba, 72beb, 72bed and 66a, and/or any combination thereof, are submitted for the approval of the owner and/or operator of the multimedia network 10.

In step 66d, it is determined whether the submission submitted in the step 66c is approved by the owner and/or operator of the network, or any affiliate or agent thereof. In an exemplary embodiment, an approval coordinator and/or committee affiliated with the owner and/or operator of the network 10 determines whether the submission submitted in the step 66c is approved.

In step 66e, if the submission submitted in the step 66c is approved in the step 66d, then high-definition video files are created using final delivery specifications, if such high-definition video files have not already been created. In an exemplary embodiment, the final delivery specifications used in the step 66e include a 1080i HD, MPEG2 file format.

In an exemplary embodiment, if the portal screen 52 is selected in the step 70 as the display element 26 via which the content is to be displayed, then the final delivery specifications used in the step 66e include the following specifications: 1920 w×1080 h pixels; Quicktime file format; compression: none, animation, or graphics; and 29.97 fps, square pixels. In an exemplary embodiment, if the portal screen 52 is selected in the step 70 as the display element 26 via which the content is to be displayed, then the final delivery specifications used in the step 66e include the following specifications: 1920 w×1080 h pixels; TGA Frame Sequence; zero padded index naming; and 29.97 fps, square pixels. In an exemplary embodiment, if the portal screen 52 is selected in the step 70 as the display element 26 via which the content is to be displayed, then the final delivery specifications used in the step 66e include the following specifications: 968 w×544 h pixels; Quicktime file format; no compression; and 29.97 fps, square pixels.

In an exemplary embodiment, if the tower video screens 50a and/or 50b is selected in the step 70 as the display elements 26 via which the content is to be displayed, then the final delivery specifications used in the step 66e include the following specifications: each tower screen 50, 594 w×576 h pixels; Quicktime file format; no compression; 29.97 fps, square pixels; and no audio.

In an exemplary embodiment, if one or more of the kiosk displays 40b is selected in the step 70 as the display elements 26 via which the content is to be displayed, then the final delivery specifications used in the step 66e include the following specifications: 1080 w×1920 h pixels (portrait mode); Quicktime file format; no compression; 29.97 fps, square pixels; and mono.

In an exemplary embodiment, if one or more of the plaza screens 48a, 48b, 48c, 48d, 48e, 48f, 48g and 48h are selected in the step 70 as the display elements 26 via which the content is to be displayed, then the final delivery specifications used in the step 66e include the following video specifications: each file, 1920 w×1080 h pixels; Quicktime file format; compression: none, animation, or graphics; and 29.97 fps, square pixels. In an exemplary embodiment, if one or more of the plaza screens 48a, 48b, 48c, 48d, 48e, 48f, 48g and 48h are selected in the step 70 as the display elements 26 via which the content is to be displayed, then the final delivery specifications used in the step 66e include the following video specifications: each file, 1920 w×1080 h pixels; TGA Frame Sequence; Zero padded index naming; and 29.97 fps, square pixels. In an exemplary embodiment, if one or more of the plaza screens 48a, 48b, 48c, 48d, 48e, 48f, 48g and 48h are selected in the step 70 as the display elements 26 via which the content is to be displayed, then the final delivery specifications used in the step 66e include the following audio specifications: Mono 48 khz, 16 bit WAV (identical sound on each track). In an exemplary embodiment, if one or more of the plaza screens 48a, 48b, 48c, 48d, 48e, 48f, 48g and 48h are selected in the step 70 as the display elements 26 via which the content is to be displayed, then the final delivery specifications used in the step 66e include the following audio specifications: Stereo 48 khz, 16 bit WAV. In an exemplary embodiment, if one or more of the plaza screens 48a, 48b, 48c, 48d, 48e, 48f, 48g and 48h are selected in the step 70 as the display elements 26 via which the content is to be displayed, and the content is taped, then the final delivery specifications used in the step 66e include the following video specifications: DigiBeta format, PAL or NTSC. In an exemplary embodiment, if one or more of the plaza screens 48a, 48b, 48c, 48d, 48e, 48f, 48g and 48h are selected in the step 70 as the display elements 26 via which the content is to be displayed, then the final delivery specifications used in the step 66e include the following specifications: each file, 1589 w×901 h pixels; Quicktime file format; no compression; 29.97 fps, square pixels; and mono.

In step 66f, the high-definition files having final delivery specifications are sent to the owner and/or operator of the network 10. In an exemplary embodiment, in the step 66f, the files are sent via DVD media. In an exemplary embodiment, in the step 66f, the files are sent via physical media. In an exemplary embodiment, in the step 66f, the files are sent via a network such as, for example, the Internet and/or the network infrastructure 20. In an exemplary embodiment, in the step 66f, the files are sent to one or more nodes that are operably coupled to the network headend 16. In an exemplary embodiment, sending the high-definition files in the step 66f includes signing a license agreement that includes a license for the owner and/or operator of the network 10 to use all material included in the files for unlimited public playback.

In an exemplary embodiment, in the steps 66c and/or 66f, in addition to one or more video files, files containing storyboards and/or written elements may be submitted in, for example, *.doc and/or *.pdf file formats.

In an exemplary embodiment, and as noted above, after the content is produced and submitted in the steps 64 and 66, respectively, the content is displayed in the step 68.

In an exemplary embodiment, to display the content in the step 68, the network 10 operates as described above so that the content is displayed via, or on, one or more of the display elements 26 of the network 10, including one or more of the plaza screens 48a, 48b, 48c, 48d, 48e, 48f, 48g and 48h, the tower screens 50a and 50b, the kiosk screens 40b, and the tall wall screen 54.

In an exemplary embodiment, the urban space 18 or a portion thereof, such as the plaza 18d, may serve as a venue for a juried awards competition, during which artwork is broadcast by the network 10.

In several exemplary embodiments, one or more of the elements and/or steps of the present disclosure may be implemented using software executed on a general purpose computer system or networked computer systems, using special purpose hardware-based computer systems, or using combinations of special purpose hardware and software.

In an exemplary embodiment, as illustrated in FIG. 30, an illustrative node 74 for implementing one or more embodiments of one or more of the above-described networks, elements, methods and/or steps, and/or any combination thereof, is depicted. The node 74 includes a microprocessor 74a, an input device 74b, a storage device 74c, a video controller 74d, a system memory 74e, a display 74f, and a communication device 74g all interconnected by one or more buses 74h. In several exemplary embodiments, the storage device 74c may include a floppy drive, hard drive, CD-ROM, optical drive, any other form of storage device and/or any combination thereof. In several exemplary embodiments, the storage device 74c may include, and/or be capable of receiving, a floppy disk, CD-ROM, DVD-ROM, or any other form of computer-readable medium that may contain executable instructions. In several exemplary embodiments, the communication device 74g may include a modem, network card, or any other device to enable the node to communicate with other nodes. In several exemplary embodiments, any node represents a plurality of interconnected (whether by intranet or Internet) computer systems, including without limitation, personal computers, mainframes, PDAs, and cell phones.

In several exemplary embodiments, a computer system typically includes at least hardware capable of executing machine readable instructions, as well as the software for executing acts (typically machine-readable instructions) that produce a desired result. In several exemplary embodiments, a computer system may include hybrids of hardware and software, as well as computer sub-systems.

In several exemplary embodiments, hardware generally includes at least processor-capable platforms, such as client-machines (also known as personal computers or servers), and hand-held processing devices (such as smart phones, personal digital assistants (PDAs), or personal computing devices (PCDs), for example). In several exemplary embodiments, hardware may include any physical device that is capable of storing machine-readable instructions, such as memory or other data storage devices. In several exemplary embodiments, other forms of hardware include hardware sub-systems, including transfer devices such as modems, modem cards, ports, and port cards, for example.

In several exemplary embodiments, software includes any machine code stored in any memory medium, such as RAM or ROM, and machine code stored on other devices (such as floppy disks, flash memory, or a CD ROM, for example). In several exemplary embodiments, software may include source or object code. In several exemplary embodiments, software encompasses any set of instructions capable of being executed on a node such as, for example, on a client machine or server.

In several exemplary embodiments, combinations of software and hardware could also be used for providing enhanced functionality and performance for certain embodiments of the present disclosure. In an exemplary embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several exemplary embodiments, computer readable mediums include, for example, passive data storage, such as a random access memory (RAM) as well as semi-permanent data storage such as a compact disk read only memory (CD-ROM). One or more exemplary embodiments of the present disclosure may be embodied in the RAM of a computer to transform a standard computer into a new specific computing machine.

In several exemplary embodiments, data structures are defined organizations of data that may enable an embodiment of the present disclosure. In an exemplary embodiment, a data structure may provide an organization of data, or an organization of executable code. In several exemplary embodiments, data signals could be carried across transmission mediums and store and transport various data structures, and, thus, may be used to transport an embodiment of the present disclosure.

In several exemplary embodiments, the network 10, and/or one or more portions thereof, may be designed to work on any specific architecture. In an exemplary embodiment, one or more portions of the network 10 may be executed on a single computer, local area networks, client-server networks, wide area networks, internets, hand-held and other portable and wireless devices and networks.

In several exemplary embodiments, a database may be any standard or proprietary database software, such as Oracle, Microsoft Access, SyBase, or DBase II, for example. In several exemplary embodiments, the database may have fields, records, data, and other database elements that may be associated through database specific software. In several exemplary embodiments, data may be mapped. In several exemplary embodiments, mapping is the process of associating one data entry with another data entry. In an exemplary embodiment, the data contained in the location of a character file can be mapped to a field in a second table. In several exemplary embodiments, the physical location of the database is not limiting, and the database may be distributed. In an exemplary embodiment, the database may exist remotely from the server, and run on a separate platform. In an exemplary embodiment, the database may be accessible across the Internet. In several exemplary embodiments, more than one database may be implemented.

In several exemplary embodiments, while different steps, processes, and procedures are described as appearing as distinct acts, one or more of the steps, one or more of the processes, and/or one or more of the procedures could also be performed in different orders, simultaneously and/or sequentially. In several exemplary embodiments, the steps, processes and/or procedures could be merged into one or more steps, processes and/or procedures.

A method has been described that includes producing content for a media network comprising a plurality of display elements positioned in a space, comprising selecting a first display element from the plurality of display elements; and producing content designed to be displayed on the first display element during the operation of the media network. In an exemplary embodiment, producing the content designed to be displayed on the first display element comprises setting up a design template; and creating a segment. In an exemplary embodiment, setting up the design template comprises determining the overall canvas size for the content designed to be displayed on the first display element; and wherein creating the segment comprises producing a digital video file. In an exemplary embodiment, submitting the content for the media network after producing the content for the media network, comprising submitting the content designed to be displayed on the first display element. In an exemplary embodiment, submitting the content designed to be displayed on the first display element comprises filling out a submission form; and submitting the submission form and the digital video file for approval. In an exemplary embodiment, submitting the content designed to be displayed on the first display element further comprises if the submission is approved, then sending one or more files comprising final-delivery specifications so that the content designed to be displayed on the first display element is able to be displayed on the first display element during the operation of the media network. In an exemplary embodiment, the first display element is a type of display element; and wherein creating the segment further comprises naming the digital video file using a naming convention, the naming convention comprising a first field for identifying the title of the content designed to be displayed on the first display element, and a second field for identifying the type of display element. In an exemplary embodiment, the method comprises displaying on the first display element the content designed to be displayed on the first display element. In an exemplary embodiment, producing the content for the media network further comprises selecting a second display element from the plurality of display elements; and producing content designed to be displayed on the second display element during the operation of the media network. In an exemplary embodiment, producing the content for the media network further comprises selecting a second display element from the plurality of display elements; and selecting between first and second segment types. In an exemplary embodiment, if the first segment type is selected, then content designed to be displayed on the second display element is produced as a result of producing the content designed to be displayed on the first display element. In an exemplary embodiment, the first and second display elements comprise first and second movable display elements, respectively; and wherein the media network comprises a first configuration in which the first and second movable display elements are adapted to move in the same direction during the operation of the media network, and a second configuration in which the first and second-movable display elements are adapted to move in opposite directions during the operation of the media network. In an exemplary embodiment, producing the content for the media network further comprises if the first segment type is selected, then selecting between first and second playback orientations, the first and second playback orientations corresponding to the first and second configurations, respectively, during the operation of the media network. In an exemplary embodiment, producing the content for the media network further comprises setting up a design template; and creating a segment. In an exemplary embodiment, creating the segment comprises if the first segment type is selected, then producing one digital video file; wherein the content designed to be displayed on the first display element is produced as a result of producing the one digital video file; and wherein content designed to be displayed on the second display element is produced as a result of producing the one digital video file. In an exemplary embodiment, creating the segment comprises if the second segment type is selected, then producing two digital video files; wherein the content designed to be displayed on the first display element is produced as a result of producing one of the two digital video files; and wherein content designed to be displayed on the second display element is produced as a result of producing the other of the two digital video files. In an exemplary embodiment, creating the segment comprises producing a digital video file; and naming the digital video file using a naming convention, the naming convention comprising a first field for identifying the title of the content, and a second field for identifying the first segment type, the second segment type, the first display element or the second display element. In an exemplary embodiment, producing the content for the media network further comprises pre-visualizing the movement of the first and second movable display elements.

A computer readable medium has been described that includes a plurality of instructions stored therein, the plurality of instructions comprising instructions for providing a media experience within an urban space, comprising instructions for commonly controlling a plurality of media elements positioned in the urban space; and instructions for providing one or more integrated messages using the commonly-controlled media elements. In an exemplary embodiment, instructions for providing one or more integrated messages using the commonly-controlled media elements comprise instructions for playing one or more marketing messages on the commonly-controlled media elements. In an exemplary embodiment, the plurality of instructions further comprises instructions for integrating the one or more marketing messages with advertising associated with activities occurring within the urban space. In an exemplary embodiment, instructions for providing a media experience within the urban space comprise instructions for providing an interactive media experience within the urban space. In an exemplary embodiment, the plurality of media elements comprises a plurality of display elements. In an exemplary embodiment, the plurality of display elements comprises first and second movable display elements. In an exemplary embodiment, instructions for providing a media experience within the urban space comprise instructions for moving the first and second movable display elements. In an exemplary embodiment, instructions for moving the first and second movable display elements comprise instructions for moving the first and second movable display elements in the same direction. In an exemplary embodiment, instructions for moving the first and second movable display elements comprise instructions for moving the first and second movable display elements in opposite directions. In an exemplary embodiment, content displayed on the first movable display element mirrors content displayed on the second movable display element. In an exemplary embodiment, the urban space comprises a common open area; and wherein the first and second movable display elements are positioned on respective opposing sides of the common open area. In an exemplary embodiment, the first and second movable display elements comprise first and second movable LED screens, respectively; and wherein instructions for providing one or more integrated messages using the commonly-controlled media elements comprise instructions for displaying content related to the one or more integrated messages on the first and second movable LED screens. In an exemplary embodiment, instructions for providing a media experience within the urban space further comprise instructions for displaying content attracting and promoting activities in the common open area on a portal screen positioned in the vicinity of the common open area. In an exemplary embodiment, instructions for providing a media experience within the urban space further comprise instructions for displaying content on one or more tower screens coupled to a tower positioned in the vicinity of the common open area. In an exemplary embodiment, instructions for providing a media experience within the urban space further comprise instructions for operably coupling a network headend to the plurality of display elements; and instructions for operably coupling to the network headend one or more of the following: one or more input elements; one or more lighting elements; and one or more audio elements. In an exemplary embodiment, instructions for providing a media experience within the urban space further comprise instructions for operably coupling a network headend to the plurality of display elements; instructions for operably coupling one or more input elements to the network headend; instructions for operably coupling one or more lighting elements to the network headend; and instructions for operably coupling one or more audio elements to the network headend. In an exemplary embodiment, instructions for providing one or more integrated messages using the commonly-controlled media elements comprise instructions for displaying content related to the one or more integrated messages on kiosk screens positioned at different locations in the urban space.

A media network has been described that includes a plurality of centrally-controlled outdoor display elements positioned in an urban space and adapted to display a lifestyle-magazine approach mix of content. In an exemplary embodiment, the mix of content comprises one or more of the following: entertainment content, educational content, informational content, cultural content, community-related content and marketing content. In an exemplary embodiment, the financial model of the media network is at least partially based on sponsorship revenue. In an exemplary embodiment, the display elements are adapted to provide one or more integrated messages so that the geographic area defined by the urban space is integrated into a consolidated and consistent media experience. In an exemplary embodiment, the display elements comprise first and second movable display elements. In an exemplary embodiment, the first and second movable elements face each other across a common open area within the urban space. In an exemplary embodiment, content displayed on the second movable display element mirrors content displayed on the first movable display element. In an exemplary embodiment, the display elements comprise movable and stationary media screens. In an exemplary embodiment, the movable media screens comprise eight horizontally movable LED screens installed on the exterior-facing facades of two buildings in two four-panel groups that face each other across a common open area within the urban space. In an exemplary embodiment, the movable media screens comprise one or more movable LED screens; and wherein the stationary screens comprise one or more of the following: a tower screen, a portal screen, a tall wall screen and a kiosk screen. In an exemplary embodiment, the urban space comprises first and second buildings, the first and second buildings comprising respective portions spaced in a generally parallel relation and defining a plaza therebetween. In an exemplary embodiment, the movable screens comprise a first movable screen coupled to the first building and a second movable screen coupled to the second building, wherein the first and second movable screens face each other across the plaza. In an exemplary embodiment, the stationary screens comprise a portal screen coupled to the first building. In an exemplary embodiment, the urban space further comprises a tower positioned adjacent the second building; and wherein the stationary screens further comprise one or more tower screens coupled to the tower. In an exemplary embodiment, the media network further comprises a network headend to which the display elements are operably coupled via a network; wherein the network headend is adapted to route content to each of the display elements via the network. In an exemplary embodiment, the media network further comprises one or more lighting elements operably coupled to the network headend via the network. In an exemplary embodiment, the one or more lighting elements comprise a theatrical lighting system. In an exemplary embodiment, the media network further comprises one or more audio elements operably coupled to the network headend via the network. In an exemplary embodiment, the media network further comprises one or more input elements operably coupled to the network headend via the network.

A computer readable medium has been described that includes a plurality of instructions stored therein, the plurality of instructions comprising instructions for producing content for a media network comprising a plurality of display elements positioned in a space, comprising instructions for selecting a first display element from the plurality of display elements; and instructions for producing content designed to be displayed on the first display element during the operation of the media network. In an exemplary embodiment, instructions for producing the content designed to be displayed on the first display element comprise instructions for setting up a design template; and instructions for creating a segment. In an exemplary embodiment, instructions for setting up the design template comprise instructions for determining the overall canvas size for the content designed to be displayed on the first display element; and wherein instructions for creating the segment comprise instructions for producing a digital video file. In an exemplary embodiment, the plurality of instructions further comprises instructions for submitting the content for the media network after producing the content for the media network, comprising instructions for submitting the content designed to be displayed on the first display element. In an exemplary embodiment, instructions for submitting the content designed to be displayed on the first display element comprise instructions for filling out a submission form; and instructions for submitting the submission form and the digital video file for approval. In an exemplary embodiment, instructions for submitting the content designed to be displayed on the first display element further comprise instructions for if the submission is approved, then sending one or more files comprising final-delivery specifications so that the content designed to be displayed on the first display element is able to be displayed on the first display element during the operation of the media network. In an exemplary embodiment, the first display element is a type of display element; and wherein instructions for creating the segment further comprise instructions for naming the digital video file using a naming convention, the naming convention comprising a first field for identifying the title of the content designed to be displayed on the first display element, and a second field for identifying the type of display element. In an exemplary embodiment, the plurality of instructions further comprises instructions for displaying on the first display element the content designed to be displayed on the first display element. In an exemplary embodiment, instructions for producing the content for the media network further comprise instructions for selecting a second display element from the plurality of display elements; and instructions for producing content designed to be displayed on the second display element during the operation of the media network. In an exemplary embodiment, instructions for producing the content for the media network further comprise instructions for selecting a second display element from the plurality of display elements; and instructions for selecting between first and second segment types. In an exemplary embodiment, if the first segment type is selected, then content designed to be displayed on the second display element is produced as a result of producing the content designed to be displayed on the first display element. In an exemplary embodiment, the first and second display elements comprise first and second movable display elements, respectively; and wherein the media network comprises a first configuration in which the first and second movable display elements are adapted to move in the same direction during the operation of the media network, and a second configuration in which the first and second movable display elements are adapted to move in opposite directions during the operation of the media network. In an exemplary embodiment, instructions for producing the content for the media network further comprise instructions for if the first segment type is selected, then selecting between first and second playback orientations, the first and second playback orientations corresponding to the first and second configurations, respectively, during the operation of the media network. In an exemplary embodiment, instructions for producing the content for the media network further comprise instructions for setting up a design template; and instructions for creating a segment. In an exemplary embodiment, instructions for creating the segment comprise instructions for if the first segment type is selected, then producing one digital video file; wherein the content designed to be displayed on the first display element is produced as a result of producing the one digital video file; and wherein content designed to be displayed on the second display element is produced as a result of producing the one digital video file. In an exemplary embodiment, instructions for creating the segment comprise instructions for if the second segment type is selected, then producing two digital video files; wherein the content designed to be displayed on the first display element is produced as a result of producing one of the two digital video files; and wherein content designed to be displayed on the second display element is produced as a result of producing the other of the two digital video files. In an exemplary embodiment, instructions for creating the segment comprise instructions for producing a digital video file; and instructions for naming the digital video file using a naming convention, the naming convention comprising a first field for identifying the title of the content, and a second field for identifying the first segment type, the second segment type, the first display element or the second display element. In an exemplary embodiment, instructions for producing the content for the media network further comprise instructions for pre-visualizing the movement of the first and second movable display elements.

A system has been described that includes means for providing a media experience within an urban space, comprising means for commonly controlling a plurality of media elements positioned in the urban space; and means for providing one or more integrated messages using the commonly-controlled media elements. In an exemplary embodiment, means for providing one or more integrated messages using the commonly-controlled media elements comprises means for playing one or more marketing messages on the commonly-controlled media elements. In an exemplary embodiment, the system comprises means for integrating the one or more marketing messages with advertising associated with activities occurring within the urban space. In an exemplary embodiment, the system means for providing a media experience within the urban space comprises means for providing an interactive media experience within the urban space. In an exemplary embodiment, the plurality of media elements comprises a plurality of display elements. In an exemplary embodiment, the plurality of display elements comprises first and second movable display elements. In an exemplary embodiment, means for providing a media experience within the urban space comprises means for moving the first and second movable display elements. In an exemplary embodiment, means for moving the first and second movable display elements comprises means for moving the first and second movable display elements in the same direction. In an exemplary embodiment, means for moving the first and second movable display elements comprises means for moving the first and second movable display elements in opposite directions. In an exemplary embodiment, content displayed on the first movable display element mirrors content displayed on the second movable display element. In an exemplary embodiment, the urban space comprises a common open area; and wherein means for providing a media experience within the urban space further comprises means for positioning the first and second movable display elements on respective opposing sides of the common open area. In an exemplary embodiment, the first and second movable display elements comprise first and second movable LED screens, respectively; and wherein means for providing one or more integrated messages using the commonly-controlled media elements comprises means for displaying content related to the one or more integrated messages on the first and second movable LED screens. In an exemplary embodiment, means for providing a media experience within the urban space further comprises means for displaying content attracting and promoting activities in the common open area on a portal screen positioned in the vicinity of the common open area. In an exemplary embodiment, means for providing a media experience within the urban space further comprises means for displaying content on one or more tower screens coupled to a tower positioned in the vicinity of the common open area. In an exemplary embodiment, means for providing a media experience within the urban space further comprises means for operably coupling a network headend to the plurality of display elements; and means for operably coupling to the network headend one or more of the following: one or more input elements; one or more lighting elements; and one or more audio elements. In an exemplary embodiment, means for providing a media experience within the urban space further comprises means for operably coupling a network headend to the plurality of display elements; means for operably coupling one or more input elements to the network headend; means for operably coupling one or more lighting elements to the network headend; and means for operably coupling one or more audio elements to the network headend. In an exemplary embodiment, means for providing one or more integrated messages using the commonly-controlled media elements comprises means for displaying content related to the one or more integrated messages on kiosk screens positioned at different locations in the urban space.

A system has been described that includes means for producing content for a media network comprising a plurality of display elements positioned in a space, comprising means for selecting a first display element from the plurality of display elements; and means for producing content designed to be displayed on the first display element during the operation of the media network. In an exemplary embodiment, means for producing the content designed to be displayed on the first display element comprises means for setting up a design template; and means for creating a segment. In an exemplary embodiment, means for setting up the design template comprises means for determining the overall canvas size for the content designed to be displayed on the first display element; and wherein means for creating the segment comprises means for producing a digital video file. In an exemplary embodiment, the system further comprises means for submitting the content for the media network after producing the content for the media network, comprising means for submitting the content designed to be displayed on the first display element. In an exemplary embodiment, means for submitting the content designed to be displayed on the first display element comprises means for filling out a submission form; and means for submitting the submission form and the digital video file for approval. In an exemplary embodiment, means for submitting the content designed to be displayed on the first display element further comprises means for if the submission is approved, then sending one or more files comprising final-delivery specifications so that the content designed to be displayed on the first display element is able to be displayed on the first display element during the operation of the media network. In an exemplary embodiment, the first display element is a type of display element; and wherein means for creating the segment further comprises means for naming the digital video file using a naming convention, the naming convention comprising a first field for identifying the title of the content designed to be displayed on the first display element, and a second field for identifying the type of display element. In an exemplary embodiment, the system further comprises means for displaying on the first display element the content designed to be displayed on the first display element. In an exemplary embodiment, means for producing the content for the media network further comprises means for selecting a second display element from the plurality of display elements; and means for producing content designed to be displayed on the second display element during the operation of the media network. In an exemplary embodiment, means for producing the content for the media network further comprises means for selecting a second display element from the plurality of display elements; and means for selecting between first and second segment types. In an exemplary embodiment, the system comprises if the first segment type is selected, then content designed to be displayed on the second display element is produced as a result of producing the content designed to be displayed on the first display element. In an exemplary embodiment, the first and second display elements comprise first and second movable display elements, respectively; and wherein the media network comprises a first configuration in which the first and second movable display elements are adapted to move in the same direction during the operation of the media network, and a second configuration in which the first and second movable display elements are adapted to move in opposite directions during the operation of the media network. In an exemplary embodiment, means for producing the content for the media network further comprises means for if the first segment type is selected, then selecting between first and second playback orientations, the first and second playback orientations corresponding to the first and second configurations, respectively, during the operation of the media network. In an exemplary embodiment, means for producing the content for the media network further comprises means for setting up a design template; and means for creating a segment. In an exemplary embodiment, means for creating the segment comprises means for if the first segment type is selected, then producing one digital video file; wherein the content designed to be displayed on the first display element is produced as a result of producing the one digital video file; and wherein content designed to be displayed on the second display element is produced as a result of producing the one digital video file. In an exemplary embodiment, means for creating the segment comprises means for if the second segment type is selected, then producing two digital video files; wherein the content designed to be displayed on the first display element is produced as a result of producing one of the two digital video files; and wherein content designed to be displayed on the second display element is produced as a result of producing the other of the two digital video files. In an exemplary embodiment, means for creating the segment comprises means for producing a digital video file; and means for naming the digital video file using a naming convention, the naming convention comprising a first field for identifying the title of the content, and a second field for identifying the first segment type, the second segment type, the first display element or the second display element. In an exemplary embodiment, means for producing the content for the media network further comprises means for pre-visualizing the movement of the first and second movable display elements.

A method has been described that includes providing a media experience within an urban space, comprising commonly controlling a plurality of media elements positioned in the urban space; and providing one or more integrated messages using the commonly-controlled media elements. In an exemplary embodiment, providing one or more integrated messages using the commonly-controlled media elements comprises playing one or more marketing messages on the commonly-controlled media elements. In an exemplary embodiment, the method further comprises integrating the one or more marketing messages with advertising associated with activities occurring within the urban space. In an exemplary embodiment, providing a media experience within the urban space comprises providing an interactive media experience within the urban space. In an exemplary embodiment, the plurality of media elements comprises a plurality of display elements. In an exemplary embodiment, the plurality of display elements comprises first and second movable display elements. In an exemplary embodiment, providing a media experience within the urban space comprises moving the first and second movable display elements. In an exemplary embodiment, moving the first and second movable display elements comprises moving the first and second movable display elements in the same direction. In an exemplary embodiment, moving the first and second movable display elements comprises moving the first and second movable display elements in opposite directions. In an exemplary embodiment, content displayed on the first movable display element mirrors content displayed on the second movable display element. In an exemplary embodiment, the urban space comprises a common open area; and wherein providing a media experience within the urban space further comprises positioning the first and second movable display elements on respective opposing sides of the common open area. In an exemplary embodiment, the first and second movable display elements comprise first and second movable LED screens, respectively; and wherein providing one or more integrated messages using the commonly-controlled media elements comprises displaying content related to the one or more integrated messages on the first and second movable LED screens. In an exemplary embodiment, providing a media experience within the urban space further comprises displaying content attracting and promoting activities in the common open area on a portal screen positioned in the vicinity of the common open area. In an exemplary embodiment, providing a media experience within the urban space further comprises displaying content on one or more tower screens coupled to a tower positioned in the vicinity of the common open area. In an exemplary embodiment, providing a media experience within the urban space further comprises operably coupling a network headend to the plurality of display elements; and operably coupling to the network headend one or more of the following: one or more input elements; one or more lighting elements; and one or more audio elements. In an exemplary embodiment, providing a media experience within the urban space further comprises operably coupling a network headend to the plurality of display elements; operably coupling one or more input elements to the network headend; operably coupling one or more lighting elements to the network headend; and operably coupling one or more audio elements to the network headend. In an exemplary embodiment, providing one or more integrated messages using the commonly-controlled media elements comprises displaying content related to the one or more integrated messages on kiosk screens positioned at different locations in the urban space.

A method has been described that includes providing a media experience within an urban space, comprising commonly controlling a plurality of media elements positioned in the urban space, the plurality of media elements comprising a plurality of display elements, the plurality of display elements comprising first and second movable display elements; providing one or more integrated messages using the commonly-controlled media elements, comprising playing one or more marketing messages on the commonly-controlled media elements; providing an interactive media experience within the urban space; moving the first and second movable display elements, comprising moving the first and second movable display elements in the same direction; and moving the first and second movable display elements in opposite directions; and integrating the one or more marketing messages with advertising associated with activities occurring within the urban space; wherein content displayed on the first movable display element mirrors content displayed on the second movable display element; wherein the urban space comprises a common open area; wherein providing a media experience within the urban space further comprises positioning the first and second movable display elements on respective opposing sides of the common open area; wherein the first and second movable display elements comprise first and second movable LED screens, respectively; wherein providing one or more integrated messages using the commonly-controlled media elements comprises displaying content related to the one or more integrated messages on the first and second movable LED screens; wherein providing a media experience within the urban space further comprises displaying content attracting and promoting activities in the common open area on a portal screen positioned in the vicinity of the common open area; displaying content on one or more tower screens coupled to a tower positioned in the vicinity of the common open area; operably coupling a network headend to the plurality of display elements; operably coupling one or more input elements to the network headend; operably coupling one or more lighting elements to the network headend; and operably coupling one or more audio elements to the network headend; and wherein providing one or more integrated messages using the commonly-controlled media elements comprises displaying content related to the one or more integrated messages on a plurality of kiosk screens positioned at different locations in the urban space.

A computer readable medium has been described that includes a plurality of instructions stored therein, the plurality of instructions comprising instructions for producing content for a media network comprising a plurality of display elements positioned in a space, comprising instructions for selecting a first display element from the plurality of display elements; and instructions for producing content designed to be displayed on the first display element during the operation of the media network; instructions for selecting a second display element from the plurality of display elements; and instructions for selecting between first and second segment types; wherein the first and second display elements comprise first and second movable display elements, respectively; wherein the media network comprises a first configuration in which the first and second movable display elements are adapted to move in the same direction during the operation of the media network, and a second configuration in which the first and second movable display elements are adapted to move in opposite directions during the operation of the media network; wherein instructions for producing the content for the media network further comprise instructions for if the first segment type is selected, then selecting between first and second playback orientations, the first and second playback orientations corresponding to the first and second configurations, respectively, during the operation of the media network; instructions for setting up a design template; instructions for creating a segment, comprising instructions for if the first segment type is selected, then producing one digital video file, wherein the content designed to be displayed on the first display element is produced as a result of producing the one digital video file, and content designed to be displayed on the second display element is produced as a result of producing the one digital video file; and instructions for if the second segment type is selected, then producing two digital video files, wherein the content designed to be displayed on the first display element is produced as a result of producing one of the two digital video files, and content designed to be displayed on the second display element is produced as a result of producing the other of the two digital video files; instructions for pre-visualizing the movement of the first and second movable display elements; and instructions for naming each digital video file using a naming convention, the naming convention comprising a first field for identifying the title of the content, and a second field for identifying the first segment type, the second segment type, the first display element or the second display element; and wherein the plurality of instructions further comprises instructions for submitting the content for the media network after producing the content for the media network, comprising instructions for filling out a submission form; instructions for submitting the submission form and at least one digital video file for approval; and instructions for if the submission is approved, then sending one or more files comprising final-delivery specifications so that the content designed to be displayed on the first display element is able to be displayed on the first display element during the operation of the media network; and the content designed to be displayed on the second display element is able to be displayed on the second display element during the operation of the media network.

A media network has been described that includes a plurality of centrally-controlled outdoor display elements positioned in an urban space and adapted to display a lifestyle-magazine approach mix of content, the display elements comprising movable and stationary media screens; a network headend to which the display elements are operably coupled via a network; one or more lighting elements operably coupled to the network headend via the network; one or more audio elements operably coupled to the network headend via the network; and one or more input elements operably coupled to the network headend via the network; wherein the mix of content comprises one or more of the following: entertainment content, educational content, informational content, cultural content, community-related content and marketing content; wherein the urban space comprises first and second buildings, the first and second buildings comprising respective portions spaced in a generally parallel relation and defining a plaza therebetween, the urban space further comprising a tower positioned adjacent the second building; wherein the movable media screens comprise eight horizontally movable LED screens installed on the exterior-facing facades of the first and second buildings in two four-panel groups that face each other across the plaza; and wherein the stationary screens comprise a portal screen coupled to the first building, and one or more tower screens coupled to the tower.

A system has been described that includes means for producing content for a media network comprising a plurality of display elements positioned in a space, comprising means for selecting a first display element from the plurality of display elements; and means for producing content designed to be displayed on the first display element during the operation of the media network; means for selecting a second display element from the plurality of display elements; and means for selecting between first and second segment types; wherein the first and second display elements comprise first and second movable display elements, respectively; wherein the media network comprises a first configuration in which the first and second movable display elements are adapted to move in the same direction during the operation of the media network, and a second configuration in which the first and second movable display elements are adapted to move in opposite directions during the operation of the media network; wherein means for producing the content for the media network further comprises means for if the first segment type is selected, then selecting between first and second playback orientations, the first and second playback orientations corresponding to the first and second configurations, respectively, during the operation of the media network; means for setting up a design template; means for creating a segment, comprising means for if the first segment type is selected, then producing one digital video file, wherein the content designed to be displayed on the first display element is produced as a result of producing the one digital video file, and content designed to be displayed on the second display element is produced as a result of producing the one digital video file; and means for if the second segment type is selected, then producing two digital video files, wherein the content designed to be displayed on the first display element is produced as a result of producing one of the two digital video files, and content designed to be displayed on the second display element is produced as a result of producing the other of the two digital video files; means for pre-visualizing the movement of the first and second movable display elements; and means for naming each digital video file using a naming convention, the naming convention comprising a first field for identifying the title of the content, and a second field for identifying the first segment type, the second segment type, the first display element or the second display element; and wherein the system further comprises means for submitting the content for the media network after producing the content for the media network, comprising means for filling out a submission form; means for submitting the submission form and at least one digital video file for approval; and means for if the submission is approved, then sending one or more files comprising final-delivery specifications so that the content designed to be displayed on the first display element is able to be displayed on the first display element during the operation of the media network; and the content designed to be displayed on the second display element is able to be displayed on the second display element during the operation of the media network.

A system has been described that includes means for providing a media experience within an urban space, comprising means for commonly controlling a plurality of media elements positioned in the urban space, the plurality of media elements comprising a plurality of display elements, the plurality of display elements comprising first and second movable display elements; means for providing one or more integrated messages using the commonly-controlled media elements, comprising means for playing one or more marketing messages on the commonly-controlled media elements; means for providing an interactive media experience within the urban space; means for moving the first and second movable display elements, comprising means for moving the first and second movable display elements in the same direction; and means for moving the first and second movable display elements in opposite directions; and means for integrating the one or more marketing messages with advertising associated with activities occurring within the urban space; wherein content displayed on the first movable display element mirrors content displayed on the second movable display element; wherein the urban space comprises a common open area; wherein means for providing a media experience within the urban space further comprises means for positioning the first and second movable display elements on respective opposing sides of the common open area; wherein the first and second movable display elements comprise first and second movable LED screens, respectively; wherein means for providing one or more integrated messages using the commonly-controlled media elements comprises means for displaying content related to the one or more integrated messages on the first and second movable LED screens; wherein means for providing a media experience within the urban space further comprises means for displaying content attracting and promoting activities in the common open area on a portal screen positioned in the vicinity of the common open area; means for displaying content on one or more tower screens coupled to a tower positioned in the vicinity of the common open area; means for operably coupling a network headend to the plurality of display elements; means for operably coupling one or more input elements to the network headend; means for operably coupling one or more lighting elements to the network headend; and means for operably coupling one or more audio elements to the network headend; and wherein means for providing one or more integrated messages using the commonly-controlled media elements comprises means for displaying content related to the one or more integrated messages on a plurality of kiosk screens positioned at different locations within the urban space.

A method has been described that includes producing content for a media network comprising a plurality of display elements positioned in a space, comprising selecting a first display element from the plurality of display elements; and producing content designed to be displayed on the first display element during the operation of the media network; selecting a second display element from the plurality of display elements; and selecting between first and second segment types; wherein the first and second display elements comprise first and second movable display elements, respectively; wherein the media network comprises a first configuration in which the first and second movable display elements are adapted to move in the same direction during the operation of the media network, and a second configuration in which the first and second movable display elements are adapted to move in opposite directions during the operation of the media network; wherein producing the content for the media network further comprises if the first segment type is selected, then selecting between first and second playback orientations, the first and second playback orientations corresponding to the first and second configurations, respectively, during the operation of the media network; setting up a design template; creating a segment, comprising if the first segment type is selected, then producing one digital video file, wherein the content designed to be displayed on the first display element is produced as a result of producing the one digital video file, and content designed to be displayed on the second display element is produced as a result of producing the one digital video file; and if the second segment type is selected, then producing two digital video files, wherein the content designed to be displayed on the first display element is produced as a result of producing one of the two digital video files, and content designed to be displayed on the second display element is produced as a result of producing the other of the two digital video files; pre-visualizing the movement of the first and second movable display elements; and naming each digital video file using a naming convention, the naming convention comprising a first field for identifying the title of the content, and a second field for identifying the first segment type, the second segment type, the first display element or the second display element; and wherein the method further comprises submitting the content for the media network after producing the content for the media network, comprising filling out a submission form; submitting the submission form and at least one digital video file for approval; and if the submission is approved, then sending one or more files comprising final-delivery specifications so that the content designed to be displayed on the first display element is able to be displayed on the first display element during the operation of the media network; and the content designed to be displayed on the second display element is able to be displayed on the second display element during the operation of the media network.

A computer readable medium has been described that includes a plurality of instructions stored therein, the plurality of instructions comprising instructions for providing a media experience within an urban space, comprising instructions for commonly controlling a plurality of media elements positioned in the urban space, the plurality of media elements comprising a plurality of display elements, the plurality of display elements comprising first and second movable display elements; instructions for providing one or more integrated messages using the commonly-controlled media elements, comprising instructions for playing one or more marketing messages on the commonly-controlled media elements; instructions for providing an interactive media experience within the urban space; instructions for moving the first and second movable display elements, comprising instructions for moving the first and second movable display elements in the same direction; and instructions for moving the first and second movable display elements in opposite directions; and instructions for integrating the one or more marketing messages with advertising associated with activities occurring within the urban space; wherein content displayed on the first movable display element mirrors content displayed on the second movable display element; wherein the urban space comprises a common open area; wherein the first and second movable display elements are positioned on respective opposing sides of the common open area; wherein the first and second movable display elements comprise first and second movable LED screens, respectively; wherein instructions for providing one or more integrated messages using the commonly-controlled media elements comprises instructions for displaying content related to the one or more integrated messages on the first and second movable LED screens; wherein instructions for providing a media experience within the urban space further comprise instructions for displaying content attracting and promoting activities in the common open area on a portal screen positioned in the vicinity of the common open area; instructions for displaying content on one or more tower screens coupled to a tower positioned in the vicinity of the common open area; instructions for operably coupling a network headend to the plurality of display elements; instructions for operably coupling one or more input elements to the network headend; instructions for operably coupling one or more lighting elements to the network headend; and instructions for operably coupling one or more audio elements to the network headend; and wherein instructions for providing one or more integrated messages using the commonly-controlled media elements comprise instructions for displaying content related to the one or more integrated messages on a plurality of kiosk screens positioned at different locations within the urban space.

An urban media network has been described that includes a plurality of centrally controlled outdoor, large format movable and stationary media screens that run a lifestyle-magazine approach programming mix of entertainment, educational, informational, and cultural content whose financial model is based on sponsorship revenue. In an exemplary embodiment, the media screens include eight horizontally movable LED screens installed on the exterior facing facades of two buildings in two four-panel groups that face each other across a common open area.

A method has been described that includes providing an urban media experience wherein media is played over a plurality of media devices all under common control to provide an integrated message.

An advertising method has been described that includes the steps of delivering a marketing message played over an urban network of centrally controlled media screens, and integrating the marketing message with advertising associated with activities occurring within the urban area.

It is understood that variations may be made in the foregoing without departing from the scope of the disclosure. For example, the types, specifications and/or quantities of the media elements 14 in the multimedia network 10 may be varied. For another example, instead of, or in addition to the urban space 18, the multimedia network 10 may be positioned in other types of outdoor spaces such as, for example, corporate campuses, fair grounds and/or governmental complexes, etc., and/or may be positioned in indoor spaces such as, for example, one or more relatively large exhibition buildings, halls and/or complexes. For yet another example, instead of, or in addition to a Quicktime file format, the one or more of the files created in the method 62 may be in a Windows Media file format and/or other types of file formats.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “top,” “bottom,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A method comprising:
producing content for a media network comprising a plurality of display elements positioned in a space, comprising:
selecting a first display element from the plurality of display elements; and
producing content designed to be displayed on the first display element during the operation of the media network.

2. The method of claim 1 wherein producing the content designed to be displayed on the first display element comprises:
setting up a design template; and
creating a segment.

3. The method of claim 2 wherein setting up the design template comprises determining the overall canvas size for the content designed to be displayed on the first display element; and
wherein creating the segment comprises producing a digital video file.

4. The method of claim 3 further comprising:
submitting the content for the media network after producing the content for the media network, comprising:
submitting the content designed to be displayed on the first display element.

5. The method of claim 4 wherein submitting the content designed to be displayed on the first display element comprises:
filling out a submission form; and
submitting the submission form and the digital video file for approval.

6. The method of claim 5 wherein submitting the content designed to be displayed on the first display element further comprises:
if the submission is approved, then sending one or more files comprising final-delivery specifications so that the content designed to be displayed on the first display element is able to be displayed on the first display element during the operation of the media network.

7. The method of claim 3 wherein the first display element is a type of display element; and
wherein creating the segment further comprises naming the digital video file using a naming convention, the naming convention comprising a first field for identifying the title of the content designed to be displayed on the first display element, and a second field for identifying the type of display element.

8. The method of claim 1 further comprising:
displaying on the first display element the content designed to be displayed on the first display element.

9. The method of claim 1 wherein producing the content for the media network further comprises:
selecting a second display element from the plurality of display elements; and
producing content designed to be displayed on the second display element during the operation of the media network.

10. The method of claim 1 wherein producing the content for the media network further comprises:
selecting a second display element from the plurality of display elements; and
selecting between first and second segment types.

11. The method of claim 10 wherein, if the first segment type is selected, then content designed to be displayed on the second display element is produced as a result of producing the content designed to be displayed on the first display element.

12. The method of claim 10 wherein the first and second display elements comprise first and second movable display elements, respectively; and
wherein the media network comprises a first configuration in which the first and second movable display elements are adapted to move in the same direction during the operation of the media network, and a second configuration in which the first and second movable display elements are adapted to move in opposite directions during the operation of the media network.

13. The method of claim 12 wherein producing the content for the media network further comprises:
if the first segment type is selected, then selecting between first and second playback orientations, the first and second playback orientations corresponding to the first and second configurations, respectively, during the operation of the media network.

14. The method of claim 10 wherein producing the content for the media network further comprises:
setting up a design template; and
creating a segment.

15. The method of claim 14 wherein creating the segment comprises:
if the first segment type is selected, then producing one digital video file;
wherein the content designed to be displayed on the first display element is produced as a result of producing the one digital video file; and
wherein content designed to be displayed on the second display element is produced as a result of producing the one digital video file.

16. The method of claim 14 wherein creating the segment comprises:
if the second segment type is selected, then producing two digital video files;
wherein the content designed to be displayed on the first display element is produced as a result of producing one of the two digital video files; and
wherein content designed to be displayed on the second display element is produced as a result of producing the other of the two digital video files.

17. The method of claim 14 wherein creating the segment comprises:
producing a digital video file; and
naming the digital video file using a naming convention, the naming convention comprising a first field for identifying the title of the content, and a second field for identifying the first segment type, the second segment type, the first display element or the second display element.

18. The method of claim 12 wherein producing the content for the media network further comprises:
pre-visualizing the movement of the first and second movable display elements.

19. A computer readable medium comprising a plurality of instructions stored therein, the plurality of instructions comprising:
instructions for providing a media experience within an urban space, comprising:
instructions for commonly controlling a plurality of media elements positioned in the urban space; and
instructions for providing one or more integrated messages using the commonly-controlled media elements.

20. The computer readable medium of claim 19 wherein instructions for providing one or more integrated messages using the commonly-controlled media elements comprise:
instructions for playing one or more marketing messages on the commonly-controlled media elements.

21. The computer readable medium of claim 20 wherein the plurality of instructions further comprises:
instructions for integrating the one or more marketing messages with advertising associated with activities occurring within the urban space.

22. The computer readable medium of claim 19 wherein instructions for providing a media experience within the urban space comprise:
instructions for providing an interactive media experience within the urban space.

23. The computer readable medium of claim 19 wherein the plurality of media elements comprises a plurality of display elements.

24. The computer readable medium of claim 23 wherein the plurality of display elements comprises first and second movable display elements.

25. The computer readable medium of claim 24 wherein instructions for providing a media experience within the urban space comprise:
instructions for moving the first and second movable display elements.

26. The computer readable medium of claim 25 wherein instructions for moving the first and second movable display elements comprise instructions for moving the first and second movable display elements in the same direction.

27. The computer readable medium of claim 25 wherein instructions for moving the first and second movable display elements comprise instructions for moving the first and second movable display elements in opposite directions.

28. The computer readable medium of claim 24 wherein content displayed on the first movable display element mirrors content displayed on the second movable display element.

29. The computer readable medium of claim 24 wherein the urban space comprises a common open area; and
wherein the first and second movable display elements are positioned on respective opposing sides of the common open area.

30. The computer readable medium of claim 29 wherein the first and second movable display elements comprise first and second movable LED screens, respectively; and
wherein instructions for providing one or more integrated messages using the commonly-controlled media elements comprise:
instructions for displaying content related to the one or more integrated messages on the first and second movable LED screens.

31. The computer readable medium of claim 29 wherein instructions for providing a media experience within the urban space further comprise:
instructions for displaying content attracting and promoting activities in the common open area on a portal screen positioned in the vicinity of the common open area.

32. The computer readable medium of claim 29 wherein instructions for providing a media experience within the urban space further comprise:
instructions for displaying content on one or more tower screens coupled to a tower positioned in the vicinity of the common open area.

33. The computer readable medium of claim 19 wherein instructions for providing a media experience within the urban space further comprise:
instructions for operably coupling a network headend to the plurality of display elements; and
instructions for operably coupling to the network headend one or more of the following:
one or more input elements;
one or more lighting elements; and
one or more audio elements.

34. The computer readable medium of claim 19 wherein instructions for providing a media experience within the urban space further comprise:
instructions for operably coupling a network headend to the plurality of display elements;
instructions for operably coupling one or more input elements to the network headend;
instructions for operably coupling one or more lighting elements to the network headend; and
instructions for operably coupling one or more audio elements to the network headend.

35. The computer readable medium of claim 19 wherein instructions for providing one or more integrated messages using the commonly-controlled media elements comprise:
instructions for displaying content related to the one or more integrated messages on kiosk screens positioned at different locations in the urban space.

36. A media network comprising a plurality of centrally-controlled outdoor display elements positioned in an urban space and adapted to display a lifestyle-magazine approach mix of content.

37. The media network of claim 36 wherein the mix of content comprises one or more of the following: entertainment content, educational content, informational content, cultural content, community-related content and marketing content.

38. The media network of claim 36 wherein the financial model of the media network is at least partially based on sponsorship revenue.

39. The media network of claim 36 wherein the display elements are adapted to provide one or more integrated messages so that the geographic area defined by the urban space is integrated into a consolidated and consistent media experience.

40. The media network of claim 36 wherein the display elements comprise first and second movable display elements.

41. The media network of claim 40 wherein the first and second movable elements face each other across a common open area within the urban space.

42. The media network of claim 41 wherein content displayed on the second movable display element mirrors content displayed on the first movable display element.

43. The media network of claim 36 wherein the display elements comprise movable and stationary media screens.

44. The media network of claim 43 wherein the movable media screens comprise eight horizontally movable LED screens installed on the exterior-facing facades of two buildings in two four-panel groups that face each other across a common open area within the urban space.

45. The media network of claim 43 wherein the movable media screens comprise one or more movable LED screens; and wherein the stationary screens comprise one or more of the following: a tower screen, a portal screen, a tall wall screen and a kiosk screen.

46. The media network of claim 43 wherein the urban space comprises first and second buildings, the first and second buildings comprising respective portions spaced in a generally parallel relation and defining a plaza therebetween.

47. The media network of claim 46 wherein the movable screens comprise a first movable screen coupled to the first building and a second movable screen coupled to the second building, wherein the first and second movable screens face each other across the plaza.

48. The media network of claim 47 wherein the stationary screens comprise a portal screen coupled to the first building.

49. The media network of claim 48 wherein the urban space further comprises a tower positioned adjacent the second building; and wherein the stationary screens further comprise one or more tower screens coupled to the tower.

50. The media network of claim 36 further comprising a network headend to which the display elements are operably coupled via a network; wherein the network headend is adapted to route content to each of the display elements via the network.

51. The media network of claim 50 further comprising one or more lighting elements operably coupled to the network headend via the network.

52. The media network of claim 51 wherein the one or more lighting elements comprise a theatrical lighting system.

53. The media network of claim 50 further comprising one or more audio elements operably coupled to the network headend via the network.

54. The media network of claim 50 further comprising one or more input elements operably coupled to the network headend via the network.

55. A computer readable medium comprising a plurality of instructions stored therein, the plurality of instructions comprising:
instructions for producing content for a media network comprising a plurality of display elements positioned in a space, comprising:
instructions for selecting a first display element from the plurality of display elements; and
instructions for producing content designed to be displayed on the first display element during the operation of the media network.

56. The computer readable medium of claim 55 wherein instructions for producing the content designed to be displayed on the first display element comprise:
instructions for setting up a design template; and
instructions for creating a segment.

57. The computer readable medium of claim 56 wherein instructions for setting up the design template comprise instructions for determining the overall canvas size for the content designed to be displayed on the first display element; and
wherein instructions for creating the segment comprise instructions for producing a digital video file.

58. The computer readable medium of claim 57 wherein the plurality of instructions further comprises:
instructions for submitting the content for the media network after producing the content for the media network, comprising:
instructions for submitting the content designed to be displayed on the first display element.

59. The computer readable medium of claim 58 wherein instructions for submitting the content designed to be displayed on the first display element comprise:
instructions for filling out a submission form; and
instructions for submitting the submission form and the digital video file for approval.

60. The computer readable medium of claim 59 wherein instructions for submitting the content designed to be displayed on the first display element further comprise:
instructions for if the submission is approved, then sending one or more files comprising final-delivery specifications so that the content designed to be displayed on the first display element is able to be displayed on the first display element during the operation of the media network.

61. The computer readable medium of claim 57 wherein the first display element is a type of display element; and
wherein instructions for creating the segment further comprise instructions for naming the digital video file using a naming convention, the naming convention comprising a first field for identifying the title of the content designed to be displayed on the first display element, and a second field for identifying the type of display element.

62. The computer readable medium of claim 55 wherein the plurality of instructions further comprises:
instructions for displaying on the first display element the content designed to be displayed on the first display element.

63. The computer readable medium of claim 55 wherein instructions for producing the content for the media network further comprise:
instructions for selecting a second display element from the plurality of display elements; and
instructions for producing content designed to be displayed on the second display element during the operation of the media network.

64. The computer readable medium of claim 55 wherein instructions for producing the content for the media network further comprise:
instructions for selecting a second display element from the plurality of display elements; and
instructions for selecting between first and second segment types.

65. The computer readable medium of claim 64 wherein, if the first segment type is selected, then content designed to be displayed on the second display element is produced as a result of producing the content designed to be displayed on the first display element.

66. The computer readable medium of claim 64 wherein the first and second display elements comprise first and second movable display elements, respectively; and
wherein the media network comprises a first configuration in which the first and second movable display elements are adapted to move in the same direction during the operation of the media network, and a second configuration in which the first and second movable display elements are adapted to move in opposite directions during the operation of the media network.

67. The computer readable medium of claim 66 wherein instructions for producing the content for the media network further comprise:
instructions for if the first segment type is selected, then selecting between first and second playback orientations, the first and second playback orientations corresponding to the first and second configurations, respectively, during the operation of the media network.

68. The computer readable medium of claim 64 wherein instructions for producing the content for the media network further comprise:
instructions for setting up a design template; and
instructions for creating a segment.

69. The computer readable medium of claim 68 wherein instructions for creating the segment comprise:
instructions for if the first segment type is selected, then producing one digital video file;
wherein the content designed to be displayed on the first display element is produced as a result of producing the one digital video file; and
wherein content designed to be displayed on the second display element is produced as a result of producing the one digital video file.

70. The computer readable medium of claim 68 wherein instructions for creating the segment comprise:
instructions for if the second segment type is selected, then producing two digital video files;
wherein the content designed to be displayed on the first display element is produced as a result of producing one of the two digital video files; and
wherein content designed to be displayed on the second display element is produced as a result of producing the other of the two digital video files.

71. The computer readable medium of claim 68 wherein instructions for creating the segment comprise:
instructions for producing a digital video file; and
instructions for naming the digital video file using a naming convention, the naming convention comprising a first field for identifying the title of the content, and a second field for identifying the first segment type, the second segment type, the first display element or the second display element.

72. The computer readable medium of claim 66 wherein instructions for producing the content for the media network further comprise:
instructions for pre-visualizing the movement of the first and second movable display elements.

73. A system comprising:
means for providing a media experience within an urban space, comprising:
means for commonly controlling a plurality of media elements positioned in the urban space; and
means for providing one or more integrated messages using the commonly-controlled media elements.

74. The system of claim 73 wherein means for providing one or more integrated messages using the commonly-controlled media elements comprises:
means for playing one or more marketing messages on the commonly-controlled media elements.

75. The system of claim 74 further comprising:
means for integrating the one or more marketing messages with advertising associated with activities occurring within the urban space.

76. The system of claim 73 wherein means for providing a media experience within the urban space comprises:
means for providing an interactive media experience within the urban space.

77. The system of claim 73 wherein the plurality of media elements comprises a plurality of display elements.

78. The system of claim 77 wherein the plurality of display elements comprises first and second movable display elements.

79. The system of claim 78 wherein means for providing a media experience within the urban space comprises:
means for moving the first and second movable display elements.

80. The system of claim 79 wherein means for moving the first and second movable display elements comprises means for moving the first and second movable display elements in the same direction.

81. The system of claim 79 wherein means for moving the first and second movable display elements comprises means for moving the first and second movable display elements in opposite directions.

82. The system of claim 78 wherein content displayed on the first movable display element mirrors content displayed on the second movable display element.

83. The system of claim 78 wherein the urban space comprises a common open area; and
wherein means for providing a media experience within the urban space further comprises:
means for positioning the first and second movable display elements on respective opposing sides of the common open area.

84. The system of claim 83 wherein the first and second movable display elements comprise first and second movable LED screens, respectively; and
wherein means for providing one or more integrated messages using the commonly-controlled media elements comprises:
means for displaying content related to the one or more integrated messages on the first and second movable LED screens.

85. The system of claim 83 wherein means for providing a media experience within the urban space further comprises:
means for displaying content attracting and promoting activities in the common open area on a portal screen positioned in the vicinity of the common open area.

86. The system of claim 83 wherein means for providing a media experience within the urban space further comprises:
means for displaying content on one or more tower screens coupled to a tower positioned in the vicinity of the common open area.

87. The system of claim 73 wherein means for providing a media experience within the urban space further comprises:
means for operably coupling a network headend to the plurality of display elements; and
means for operably coupling to the network headend one or more of the following:
one or more input elements;
one or more lighting elements; and
one or more audio elements.

88. The system of claim 73 wherein means for providing a media experience within the urban space further comprises:
means for operably coupling a network headend to the plurality of display elements;
means for operably coupling one or more input elements to the network headend;
means for operably coupling one or more lighting elements to the network headend; and
means for operably coupling one or more audio elements to the network headend.

89. The system of claim 73 wherein means for providing one or more integrated messages using the commonly-controlled media elements comprises:
means for displaying content related to the one or more integrated messages on kiosk screens positioned at different locations in the urban space.

90. A system comprising:
means for producing content for a media network comprising a plurality of display elements positioned in a space, comprising:
means for selecting a first display element from the plurality of display elements; and
means for producing content designed to be displayed on the first display element during the operation of the media network.

91. The system of claim 90 wherein means for producing the content designed to be displayed on the first display element comprises:
means for setting up a design template; and
means for creating a segment.

92. The system of claim 91 wherein means for setting up the design template comprises means for determining the overall canvas size for the content designed to be displayed on the first display element; and
wherein means for creating the segment comprises means for producing a digital video file.

93. The system of claim 92 further comprising:
means for submitting the content for the media network after producing the content for the media network, comprising:
means for submitting the content designed to be displayed on the first display element.

94. The system of claim 93 wherein means for submitting the content designed to be displayed on the first display element comprises:
means for filling out a submission form; and
means for submitting the submission form and the digital video file for approval.

95. The system of claim 94 wherein means for submitting the content designed to be displayed on the first display element further comprises:
means for if the submission is approved, then sending one or more files comprising final-delivery specifications so that the content designed to be displayed on the first display element is able to be displayed on the first display element during the operation of the media network.

96. The system of claim 92 wherein the first display element is a type of display element; and
wherein means for creating the segment further comprises means for naming the digital video file using a naming convention, the naming convention comprising a first field for identifying the title of the content designed to be displayed on the first display element, and a second field for identifying the type of display element.

97. The system of claim 90 further comprising:
means for displaying on the first display element the content designed to be displayed on the first display element.

98. The system of claim 90 wherein means for producing the content for the media network further comprises:
means for selecting a second display element from the plurality of display elements; and
means for producing content designed to be displayed on the second display element during the operation of the media network.

99. The system of claim 90 wherein means for producing the content for the media network further comprises:
means for selecting a second display element from the plurality of display elements; and
means for selecting between first and second segment types.

100. The system of claim 99 wherein, if the first segment type is selected, then content designed to be displayed on the second display element is produced as a result of producing the content designed to be displayed on the first display element.

101. The system of claim 99 wherein the first and second display elements comprise first and second movable display elements, respectively; and
wherein the media network comprises a first configuration in which the first and second movable display elements are adapted to move in the same direction during the operation of the media network, and a second configuration in which the first and second movable display elements are adapted to move in opposite directions during the operation of the media network.

102. The system of claim 101 wherein means for producing the content for the media network further comprises:
means for if the first segment type is selected, then selecting between first and second playback orientations, the first and second playback orientations corresponding to the first and second configurations, respectively, during the operation of the media network.

103. The system of claim 99 wherein means for producing the content for the media network further comprises:
means for setting up a design template; and
means for creating a segment.

104. The system of claim 103 wherein means for creating the segment comprises:
means for if the first segment type is selected, then producing one digital video file;
wherein the content designed to be displayed on the first display element is produced as a result of producing the one digital video file; and
wherein content designed to be displayed on the second display element is produced as a result of producing the one digital video file.

105. The system of claim 103 wherein means for creating the segment comprises:
means for if the second segment type is selected, then producing two digital video files;
wherein the content designed to be displayed on the first display element is produced as a result of producing one of the two digital video files; and
wherein content designed to be displayed on the second display element is produced as a result of producing the other of the two digital video files.

106. The system of claim 103 wherein means for creating the segment comprises:
means for producing a digital video file; and
means for naming the digital video file using a naming convention, the naming convention comprising a first field for identifying the title of the content, and a second field for identifying the first segment type, the second segment type, the first display element or the second display element.

107. The system of claim 101 wherein means for producing the content for the media network further comprises:
means for pre-visualizing the movement of the first and second movable display elements.

108. A method comprising:
providing a media experience within an urban space, comprising:
commonly controlling a plurality of media elements positioned in the urban space; and
providing one or more integrated messages using the commonly-controlled media elements.

109. The method of claim 108 wherein providing one or more integrated messages using the commonly-controlled media elements comprises:
playing one or more marketing messages on the commonly-controlled media elements.

110. The method of claim 109 further comprising:
integrating the one or more marketing messages with advertising associated with activities occurring within the urban space.

111. The method of claim 108 wherein providing a media experience within the urban space comprises:
providing an interactive media experience within the urban space.

112. The method of claim 108 wherein the plurality of media elements comprises a plurality of display elements.

113. The method of claim 112 wherein the plurality of display elements comprises first and second movable display elements.

114. The method of claim 113 wherein providing a media experience within the urban space comprises:
moving the first and second movable display elements.

115. The method of claim 114 wherein moving the first and second movable display elements comprises moving the first and second movable display elements in the same direction.

116. The method of claim 114 wherein moving the first and second movable display elements comprises moving the first and second movable display elements in opposite directions.

117. The method of claim 113 wherein content displayed on the first movable display element mirrors content displayed on the second movable display element.

118. The method of claim 113 wherein the urban space comprises a common open area; and
wherein providing a media experience within the urban space further comprises:
positioning the first and second movable display elements on respective opposing sides of the common open area.

119. The method of claim 118 wherein the first and second movable display elements comprise first and second movable LED screens, respectively; and
wherein providing one or more integrated messages using the commonly-controlled media elements comprises:
displaying content related to the one or more integrated messages on the first and second movable LED screens.

120. The method of claim 118 wherein providing a media experience within the urban space further comprises:
displaying content attracting and promoting activities in the common open area on a portal screen positioned in the vicinity of the common open area.

121. The method of claim 118 wherein providing a media experience within the urban space further comprises:
displaying content on one or more tower screens coupled to a tower positioned in the vicinity of the common open area.

122. The method of claim 108 wherein providing a media experience within the urban space further comprises:
operably coupling a network headend to the plurality of display elements; and
operably coupling to the network headend one or more of the following:
one or more input elements;
one or more lighting elements; and
one or more audio elements.

123. The method of claim 108 wherein providing a media experience within the urban space further comprises:
operably coupling a network headend to the plurality of display elements;
operably coupling one or more input elements to the network headend;
operably coupling one or more lighting elements to the network headend; and
operably coupling one or more audio elements to the network headend.

124. The method of claim 108 wherein providing one or more integrated messages using the commonly-controlled media elements comprises:
displaying content related to the one or more integrated messages on kiosk screens positioned at different locations in the urban space.

125. A method comprising:
providing a media experience within an urban space, comprising:
commonly controlling a plurality of media elements positioned in the urban space, the plurality of media elements comprising a plurality of display elements, the plurality of display elements comprising first and second movable display elements;
providing one or more integrated messages using the commonly-controlled media elements, comprising:
playing one or more marketing messages on the commonly-controlled media elements;
providing an interactive media experience within the urban space;
moving the first and second movable display elements, comprising:
moving the first and second movable display elements in the same direction; and
moving the first and second movable display elements in opposite directions; and
integrating the one or more marketing messages with advertising associated with activities occurring within the urban space;
wherein content displayed on the first movable display element mirrors content displayed on the second movable display element;
wherein the urban space comprises a common open area;
wherein providing a media experience within the urban space further comprises:
positioning the first and second movable display elements on respective opposing sides of the common open area;
wherein the first and second movable display elements comprise first and second movable LED screens, respectively;
wherein providing one or more integrated messages using the commonly-controlled media elements comprises:
displaying content related to the one or more integrated messages on the first and second movable LED screens;
wherein providing a media experience within the urban space further comprises:
displaying content attracting and promoting activities in the common open area on a portal screen positioned in the vicinity of the common open area;
displaying content on one or more tower screens coupled to a tower positioned in the vicinity of the common open area;
operably coupling a network headend to the plurality of display elements;
operably coupling one or more input elements to the network headend;
operably coupling one or more lighting elements to the network headend; and
operably coupling one or more audio elements to the network headend; and
wherein providing one or more integrated messages using the commonly-controlled media elements comprises:
displaying content related to the one or more integrated messages on a plurality of kiosk screens positioned at different locations in the urban space.

126. A computer readable medium comprising a plurality of instructions stored therein, the plurality of instructions comprising:
instructions for producing content for a media network comprising a plurality of display elements positioned in a space, comprising:
instructions for selecting a first display element from the plurality of display elements; and
instructions for producing content designed to be displayed on the first display element during the operation of the media network;
instructions for selecting a second display element from the plurality of display elements; and
instructions for selecting between first and second segment types;
wherein the first and second display elements comprise first and second movable display elements, respectively;
wherein the media network comprises a first configuration in which the first and second movable display elements are adapted to move in the same direction during the operation of the media network, and a second configuration in which the first and second movable display elements are adapted to move in opposite directions during the operation of the media network;
wherein instructions for producing the content for the media network further comprise:
instructions for if the first segment type is selected, then selecting between first and second playback orientations, the first and second playback orientations corresponding to the first and second configurations, respectively, during the operation of the media network;
instructions for setting up a design template;
instructions for creating a segment, comprising:
instructions for if the first segment type is selected, then producing one digital video file, wherein:
the content designed to be displayed on the first display element is produced as a result of producing the one digital video file, and
content designed to be displayed on the second display element is produced as a result of producing the one digital video file; and
instructions for if the second segment type is selected, then producing two digital video files, wherein:
the content designed to be displayed on the first display element is produced as a result of producing one of the two digital video files, and
content designed to be displayed on the second display element is produced as a result of producing the other of the two digital video files;
instructions for pre-visualizing the movement of the first and second movable display elements; and
instructions for naming each digital video file using a naming convention, the naming convention comprising a first field for identifying the title of the content, and a second field for identifying the first segment type, the second segment type, the first display element or the second display element; and
wherein the plurality of instructions further comprises:
instructions for submitting the content for the media network after producing the content for the media network, comprising:
instructions for filling out a submission form;
instructions for submitting the submission form and at least one digital video file for approval; and
instructions for if the submission is approved, then sending one or more files comprising final-delivery specifications so that:
the content designed to be displayed on the first display element is able to be displayed on the first display element during the operation of the media network; and
the content designed to be displayed on the second display element is able to be displayed on the second display element during the operation of the media network.

127. A media network comprising a plurality of centrally-controlled outdoor display elements positioned in an urban space and adapted to display a lifestyle-magazine approach mix of content, the display elements comprising movable and stationary media screens; a network headend to which the display elements are operably coupled via a network; one or more lighting elements operably coupled to the network headend via the network; one or more audio elements operably coupled to the network headend via the network; and one or more input elements operably coupled to the network headend via the network; wherein the mix of content comprises one or more of the following: entertainment content, educational content, informational content, cultural content, community-related content and marketing content; wherein the urban space comprises first and second buildings, the first and second buildings comprising respective portions spaced in a generally parallel relation and defining a plaza therebetween, the urban space further comprising a tower positioned adjacent the second building; wherein the movable media screens comprise eight horizontally movable LED screens installed on the exterior-facing facades of the first and second buildings in two four-panel groups that face each other across the plaza; and wherein the stationary screens comprise a portal screen coupled to the first building, and one or more tower screens coupled to the tower.

128. A system comprising:
means for producing content for a media network comprising a plurality of display elements positioned in a space, comprising:
means for selecting a first display element from the plurality of display elements; and
means for producing content designed to be displayed on the first display element during the operation of the media network;
means for selecting a second display element from the plurality of display elements; and
means for selecting between first and second segment types;
wherein the first and second display elements comprise first and second movable display elements, respectively;
wherein the media network comprises a first configuration in which the first and second movable display elements are adapted to move in the same direction during the operation of the media network, and a second configuration in which the first and second movable display elements are adapted to move in opposite directions during the operation of the media network;
wherein means for producing the content for the media network further comprises:
means for if the first segment type is selected, then selecting between first and second playback orientations, the first and second playback orientations corresponding to the first and second configurations, respectively, during the operation of the media network;
means for setting up a design template;
means for creating a segment, comprising:
means for if the first segment type is selected, then producing one digital video file, wherein:
the content designed to be displayed on the first display element is produced as a result of producing the one digital video file, and
content designed to be displayed on the second display element is produced as a result of producing the one digital video file; and
means for if the second segment type is selected, then producing two digital video files, wherein:
the content designed to be displayed on the first display element is produced as a result of producing one of the two digital video files, and
content designed to be displayed on the second display element is produced as a result of producing the other of the two digital video files;
means for pre-visualizing the movement of the first and second movable display elements; and
means for naming each digital video file using a naming convention, the naming convention comprising a first field for identifying the title of the content, and a second field for identifying the first segment type, the second segment type, the first display element or the second display element; and
wherein the system further comprises:
means for submitting the content for the media network after producing the content for the media network, comprising:
means for filling out a submission form;
means for submitting the submission form and at least one digital video file for approval; and
means for if the submission is approved, then sending one or more files comprising final-delivery specifications so that:
the content designed to be displayed on the first display element is able to be displayed on the first display element during the operation of the media network; and
the content designed to be displayed on the second display element is able to be displayed on the second display element during the operation of the media network.

129. A system comprising:
means for providing a media experience within an urban space, comprising:
means for commonly controlling a plurality of media elements positioned in the urban space, the plurality of media elements comprising a plurality of display elements, the plurality of display elements comprising first and second movable display elements;
means for providing one or more integrated messages using the commonly-controlled media elements, comprising:
means for playing one or more marketing messages on the commonly-controlled media elements;
means for providing an interactive media experience within the urban space;
means for moving the first and second movable display elements, comprising:
means for moving the first and second movable display elements in the same direction; and
means for moving the first and second movable display elements in opposite directions; and
means for integrating the one or more marketing messages with advertising associated with activities occurring within the urban space;
wherein content displayed on the first movable display element mirrors content displayed on the second movable display element;
wherein the urban space comprises a common open area;
wherein means for providing a media experience within the urban space further comprises:
means for positioning the first and second movable display elements on respective opposing sides of the common open area;
wherein the first and second movable display elements comprise first and second movable LED screens, respectively;
wherein means for providing one or more integrated messages using the commonly-controlled media elements comprises:
means for displaying content related to the one or more integrated messages on the first and second movable LED screens;
wherein means for providing a media experience within the urban space further comprises:
means for displaying content attracting and promoting activities in the common open area on a portal screen positioned in the vicinity of the common open area;
means for displaying content on one or more tower screens coupled to a tower positioned in the vicinity of the common open area;
means for operably coupling a network headend to the plurality of display elements;
means for operably coupling one or more input elements to the network headend;
means for operably coupling one or more lighting elements to the network headend; and
means for operably coupling one or more audio elements to the network headend;
and
wherein means for providing one or more integrated messages using the commonly-controlled media elements comprises:
means for displaying content related to the one or more integrated messages on a plurality of kiosk screens positioned at different locations within the urban space.

130. A method comprising:
producing content for a media network comprising a plurality of display elements positioned in a space, comprising:
selecting a first display element from the plurality of display elements; and
producing content designed to be displayed on the first display element during the operation of the media network;
selecting a second display element from the plurality of display elements; and
selecting between first and second segment types;
wherein the first and second display elements comprise first and second movable display elements, respectively;
wherein the media network comprises a first configuration in which the first and second movable display elements are adapted to move in the same direction during the operation of the media network, and a second configuration in which the first and second movable display elements are adapted to move in opposite directions during the operation of the media network;
wherein producing the content for the media network further comprises:
if the first segment type is selected, then selecting between first and second playback orientations, the first and second playback orientations corresponding to the first and second configurations, respectively, during the operation of the media network;
setting up a design template;
creating a segment, comprising:
if the first segment type is selected, then producing one digital video file, wherein:
the content designed to be displayed on the first display element is produced as a result of producing the one digital video file, and
content designed to be displayed on the second display element is produced as a result of producing the one digital video file; and
if the second segment type is selected, then producing two digital video files, wherein:
the content designed to be displayed on the first display element is produced as a result of producing one of the two digital video files, and
content designed to be displayed on the second display element is produced as a result of producing the other of the two digital video files;
pre-visualizing the movement of the first and second movable display elements; and
naming each digital video file using a naming convention, the naming convention comprising a first field for identifying the title of the content, and a second field for identifying the first segment type, the second segment type, the first display element or the second display element;
and
wherein the method further comprises:
submitting the content for the media network after producing the content for the media network, comprising:
filling out a submission form;
submitting the submission form and at least one digital video file for approval; and
if the submission is approved, then sending one or more files comprising final-delivery specifications so that:
the content designed to be displayed on the first display element is able to be displayed on the first display element during the operation of the media network; and
the content designed to be displayed on the second display element is able to be displayed on the second display element during the operation of the media network.

131. A computer readable medium comprising a plurality of instructions stored therein, the plurality of instructions comprising:
instructions for providing a media experience within an urban space, comprising:
instructions for commonly controlling a plurality of media elements positioned in the urban space, the plurality of media elements comprising a plurality of display elements, the plurality of display elements comprising first and second movable display elements;
instructions for providing one or more integrated messages using the commonly-controlled media elements, comprising instructions for playing one or more marketing messages on the commonly-controlled media elements;
instructions for providing an interactive media experience within the urban space;
instructions for moving the first and second movable display elements, comprising:
instructions for moving the first and second movable display elements in the same direction; and
instructions for moving the first and second movable display elements in opposite directions; and
instructions for integrating the one or more marketing messages with advertising associated with activities occurring within the urban space;
wherein content displayed on the first movable display element mirrors content displayed on the second movable display element;
wherein the urban space comprises a common open area;
wherein the first and second movable display elements are positioned on respective opposing sides of the common open area;
wherein the first and second movable display elements comprise first and second movable LED screens, respectively;
wherein instructions for providing one or more integrated messages using the commonly-controlled media elements comprise instructions for displaying content related to the one or more integrated messages on the first and second movable LED screens;
wherein instructions for providing a media experience within the urban space further comprise:
instructions for displaying content attracting and promoting activities in the common open area on a portal screen positioned in the vicinity of the common open area;
instructions for displaying content on one or more tower screens coupled to a tower positioned in the vicinity of the common open area;
instructions for operably coupling a network headend to the plurality of display elements;
instructions for operably coupling one or more input elements to the network headend;
instructions for operably coupling one or more lighting elements to the network headend; and
instructions for operably coupling one or more audio elements to the network headend;
and
wherein instructions for providing one or more integrated messages using the commonly-controlled media elements comprise instructions for displaying content related to the one or more integrated messages on a plurality of kiosk screens positioned at different locations within the urban space.

132. An urban media network comprising a plurality of centrally controlled outdoor, large format movable and stationary media screens that run a lifestyle-magazine approach programming mix of entertainment, educational, informational, and cultural content whose financial model is based on sponsorship revenue.

133. The network of claim 132 wherein the media screens include eight horizontally movable LED screens installed on the exterior facing facades of two buildings in two four-panel groups that face each other across a common open area.

134. A method of providing an urban media experience wherein media is played over a plurality of media devices all under common control to provide an integrated message.

135. An advertising method comprising the steps of delivering a marketing message played over an urban network of centrally controlled media screens, and integrating the marketing message with advertising associated with activities occurring within the urban area.
